(19) United States
(12) Patent Application Publication
(10) Pub. No.: US 2013/0246106 A1
(43) Pub. Date: Sep. 19, 2013

(54) HIERARCHICAL BUDGET PROCESS ORCHESTRATION

(71) Applicants: Kimberly J. Kroetsch, Fargo, ND (US); Ramaswamy Narayana, Sammamish, WA (US); Neil D. Robinson, Bellevue, WA (US)

(72) Inventors: Kimberly J. Kroetsch, Fargo, ND (US); Ramaswamy Narayana, Sammamish, WA (US); Neil D. Robinson, Bellevue, WA (US)

(73) Assignee: MICROSOFT CORPORATION, Redmond, WA (US)

(21) Appl. No.: 13/549,531

(22) Filed: Jul. 16, 2012

Related U.S. Application Data
(60) Provisional application No. 61/611,388, filed on Mar. 15, 2012.

(51) Int. Cl. G06Q 10/06

(52) U.S. Cl. 705/7.12

(57) ABSTRACT

A hierarchical budgeting structure is generated and used for generating and reviewing budgets during the budget planning process. Automated workflows for generating the budget and iteratively reviewing the budget are determined based upon the hierarchical budgeting structure. The hierarchical budgeting structure is first defined and that hierarchical budgeting structure is used to control flow of the information during the budget planning process. Nodes in the hierarchal structure each have an associated workflow and a set of rules that control activities that can be performed at a given node and that control security features corresponding to that node.

The present application is based on and claims the benefit of U.S. provisional patent application Ser. No. 61/611,388, filed Mar. 15, 2012, the content of which is hereby incorporated by reference in its entirety.

### BACKGROUND

The process of planning a budget or generating a budget is often a very complicated process. Normally, this is a highly manual process and can require a great deal of time and effort, and it can also be inefficient and error prone.

The budget planning process often requires many different iterations, and the particular process used in formulating and iterating through budget revisions is often defined by a budget hierarchy of an organization. However, the budget hierarchy does not always match the organization hierarchy of the organization. For instance, a budget hierarchy may require input from different individuals or groups within an organization, that are not separately defined within the structure of the organizational hierarchy. Nonetheless, those individuals or groups may be required to provide input to, or to review, budgets during the planning process. Because of the very complicated and iterative budgeting process, many organizations fall back to a manual process for generating a budget.

The problems associated with the budget planning process can be exacerbated as the complexity of the organization generating the budget grows. The more complex the organization, the more complex the budget planning process. Similarly, many organizations go through regular restructuring. This can require modifications and retraining of individuals involved in the budget planning process.

Some organizations regularly revise their budget planning process. This requires constant updates to the process, and this exacerbates the cumbersome nature of the process as well.

Further, budget data is often extremely sensitive data. This can require additional security to control access to the data, even for those individuals who are involved in the budget planning process.

It should also be noted that the process of developing or creating a budget is not only important to private sector entities, but to public sector organizations as well. In the public sector, the budget often represents the entity's legal authority to spend based on planned revenues. Even the highest level government officials cannot spend government resources, without properly established budget authority.

It is common for public sector organizations to prepare two types of budgets. An operating budget often spans one or two years and the capital budget spans multiple years and is commonly a rolling multi-year plan (such as a rolling 5-year plan). An operating budget includes a spending plan for continuing services and strategic initiatives of short term duration. A capital budget includes a spending plan for asset acquisitions or construction projects.

With all of these budgets, budget planning is a cyclical process that is often repeated annually or bi-annually with many phases and stages. Budget planning is also an iterative process wherein data is analyzed in many scenarios within a stage to develop an optimum budget proposal.

The discussion above is merely provided for general background information and is not intended to be used as an aid in determining the scope of the claimed subject matter.

### SUMMARY

A hierarchical budgeting structure is generated and used for generating and reviewing budgets during the budget planning process. Automated workflows for generating the budget and iteratively reviewing the budget are determined based upon the hierarchical budgeting structure. The hierarchical budgeting structure is first defined and that hierarchical budgeting structure is used to control flow of the information during the budget planning process. Nodes in the hierarchal structure each have an associated workflow and a set of rules that control activities that can be performed at a given node and that control security features corresponding to that node.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative embodiment of a budget planning system.

FIG. 2 is a flow diagram illustrating the overall operation of the system shown in FIG. 1.

FIGS. 2A-2B show illustrative organizational budget hierarchies used for budget planning

FIG. 2C shows an exemplary user interface display of a hierarchy of budget plans for the organizational budget hierarchy shown in FIG. 2B.

FIGS. 3A and 3B are a flow chart illustrating the operation of the system shown in FIG. 1 in more detail.

FIGS. 3C-3O are illustrative user interface displays.

FIG. 4 is a flow diagram illustrating the creation of an organization structure with a budget planning purpose in greater detail.

FIG. 5 is a flow diagram illustrating one embodiment of the operation of the system shown in FIG. 1 in aggregating information from child (or descendent) budget plans to a parent (or ancestor) budget plan.

FIG. 5A is an illustrative user interface display.

FIG. 6 is a flow diagram illustrating one embodiment of the operation of the system shown in FIG. 1 in distributing information from a parent plan to child plans.

FIG. 6A is an illustrative user interface display.

FIGS. 7A and 7B are illustrative user interface displays showing allocations from one scenario to another and from one stage to another, respectively.

FIG. 8 is a flow diagram illustrating the creation of a parent plan for a set of child plans.

FIG. 9 is a flow diagram illustrating the operation of the system shown in FIG. 1 in navigating though a hierarchical budget plan structure.

FIG. 10 is one illustrative architecture.

FIG. 11-15 are illustrative mobile devices.

FIG. 16 is one illustrative computing environment.

### DETAILED DESCRIPTION

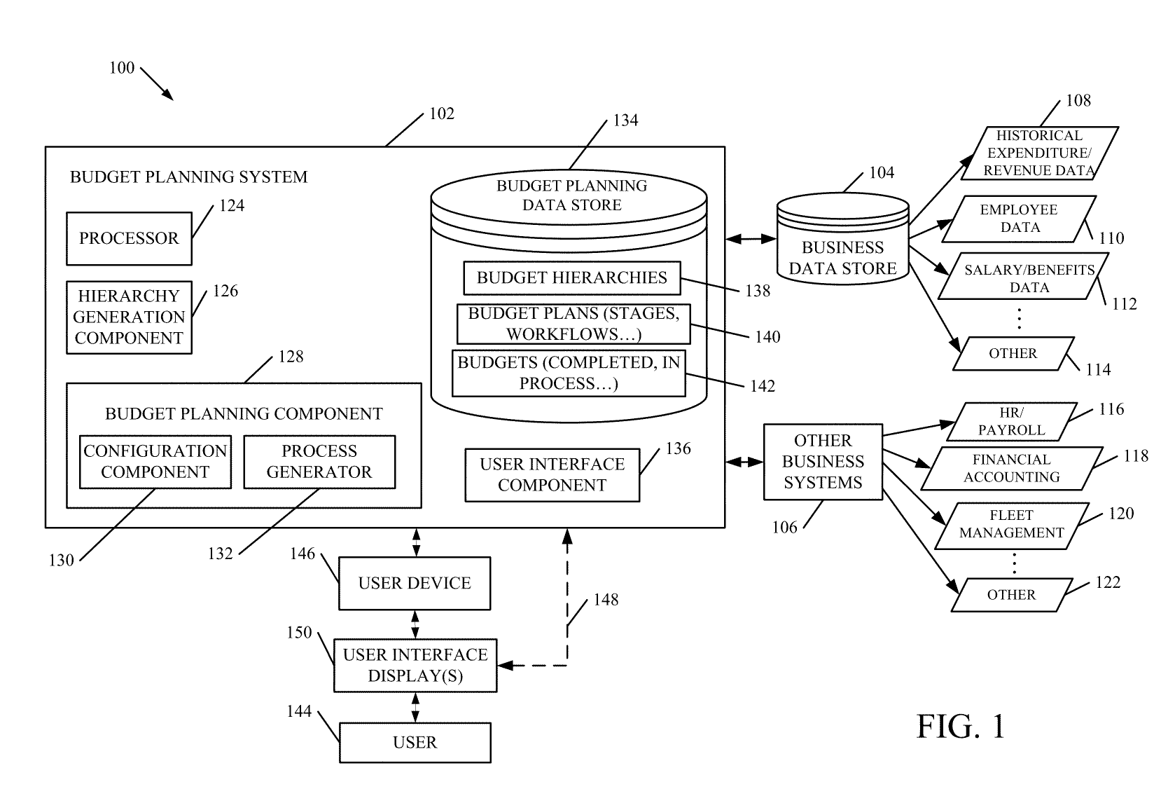

FIG. 1 is a block diagram of one illustrative business system 100 that includes budget planning system 102, business data store 104 and other business systems 106. Business data store 104 holds a variety of different business data including historical expenditure and revenue data 108, employee data 110, salary/benefit data 112, and a variety of other business data 114. Business data store 104 can, of course, be a single data store or multiple data stores that are located in the same place, or remotely from one another. Business data store 104 also illustratively stores business data records for customers, accounts, and a variety of other business data records that correspond to business applications that may be run by a business.

Other business systems 106 illustratively include human resource (HR) and payroll system 116, financial/accounting system 118, fleet management system 120 and other systems 122. Other systems 122 may, for instance, include customer resource management (CRM) systems, enterprise resource planning (ERP) systems, line of business (LOB) applications, or other business systems or applications that are used by a business.

In the embodiment shown in FIG. 1, budget planning system 102 illustratively includes processor 124, hierarchy generation component 126, budget planning component 128 (which itself includes configuration component 130 and process generator 132), budget planning data store 134 and user interface component 136. Budget planning data store 134 illustratively includes budget hierarchies 138, budget plans (including things such as stages and workflows) 140 and budgets (which can be completed, in process, etc.) 142.

In one embodiment, user 144 accesses budget planning system 102 to generate a budget plan for generating one or more budgets. Of course, user 144 can access system 102 either through a user device 146, or directly, as indicated by arrow 148. In any case, either user device 146 or user interface component 136 generates user interface displays 150 which illustratively include user input mechanisms which user 144 can interact with in order to provide inputs to interact with budget planning system 102. A number of illustrative user interface displays are described below.

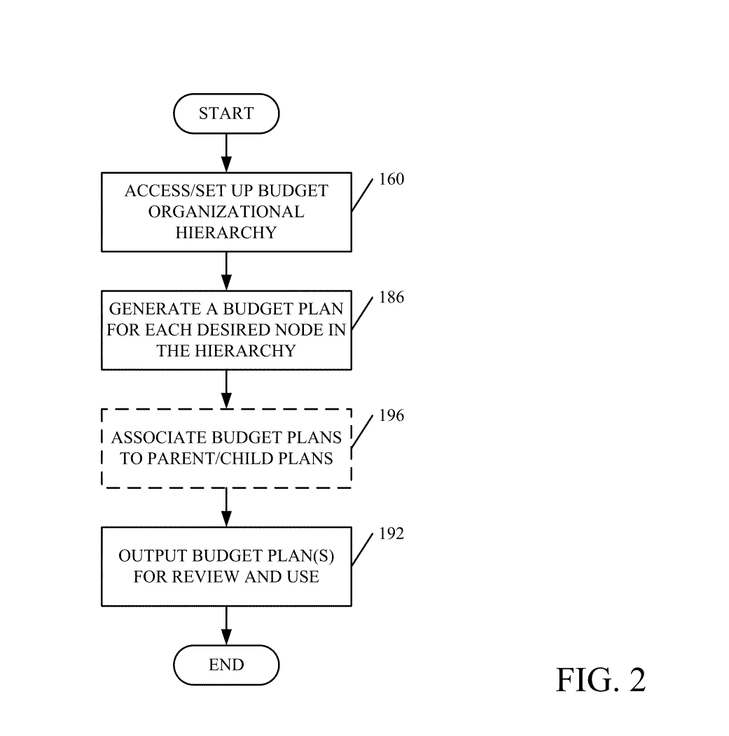

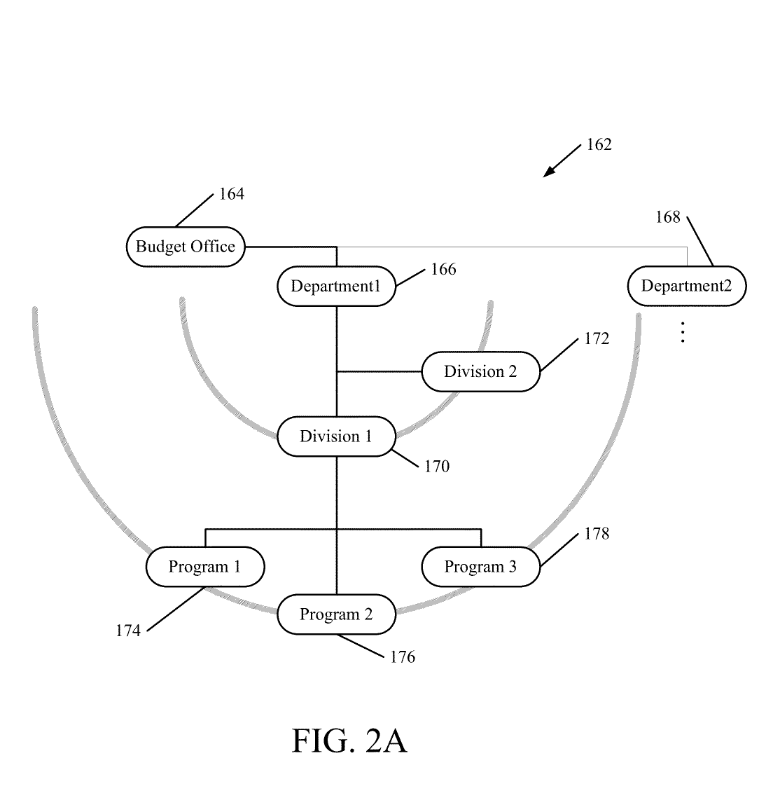

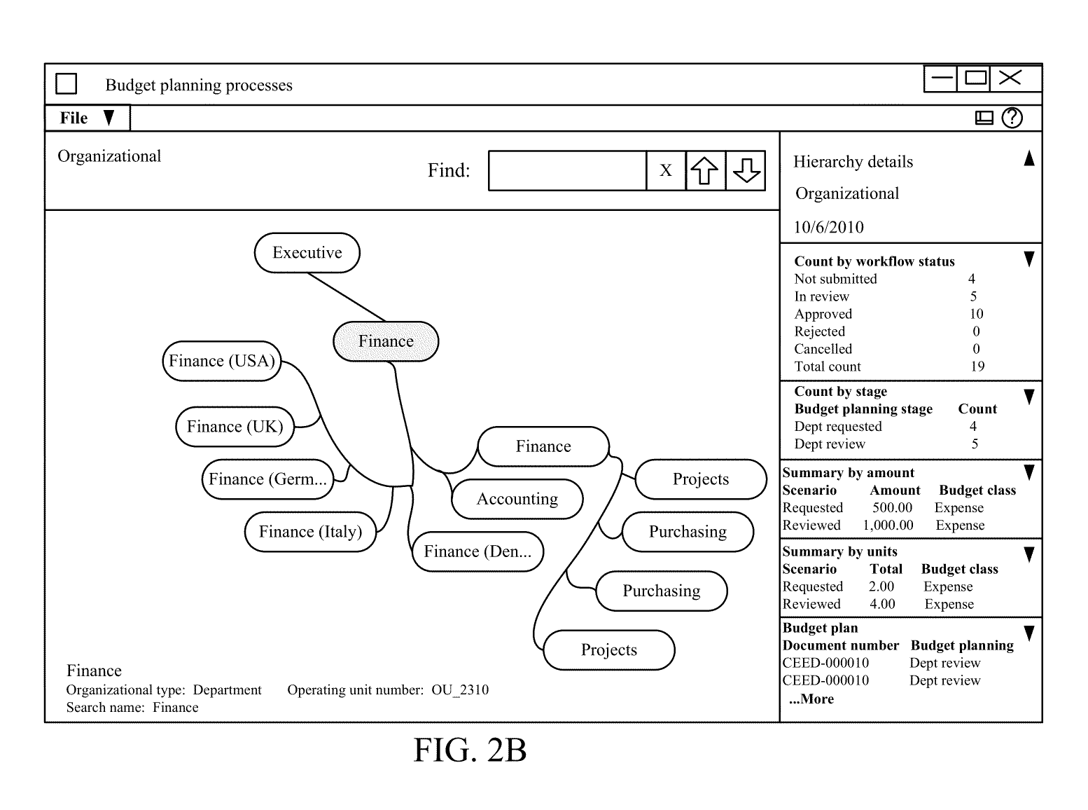

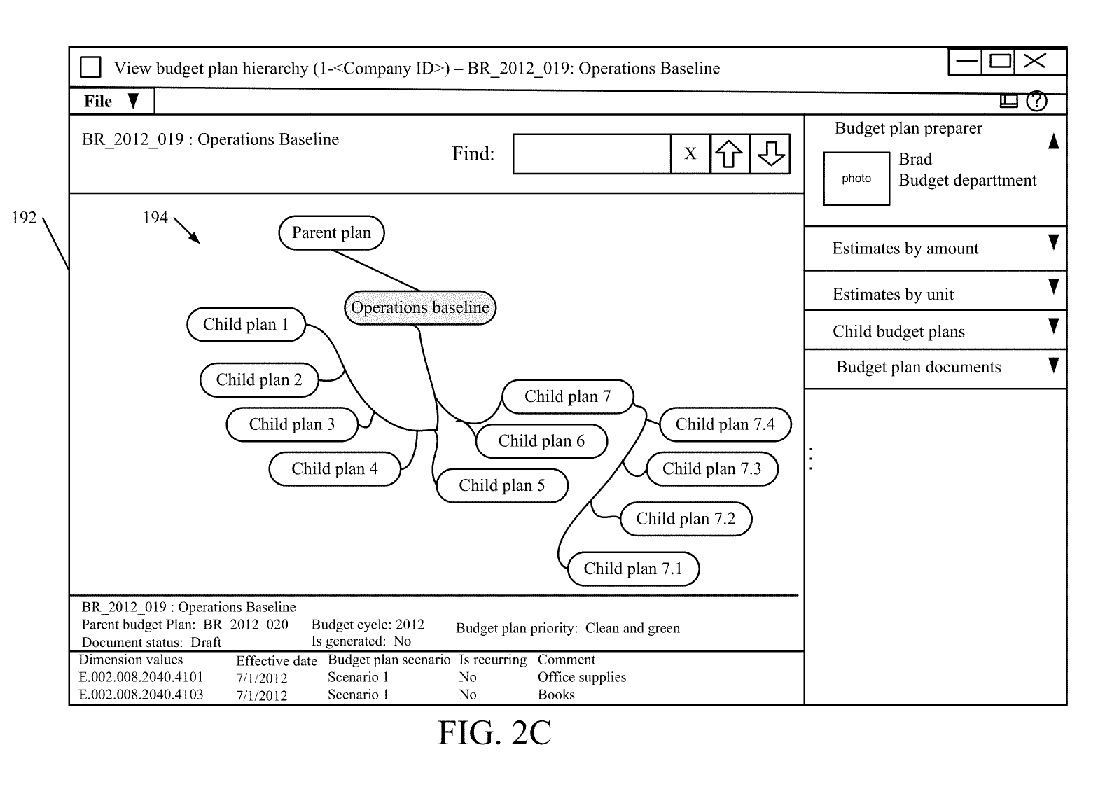

FIG. 2 is a flow diagram illustrating one embodiment of the operation of budget planning system 102 in generating a budget plan for use by individuals in generating a budget. In one embodiment, budget planning data store 134 holds budget hierarchies (and/or budget organizational hierarchies) 138 which have already been generated by hierarchy generation component 126. As discussed in the background section above, it may be that the budget hierarchy is different than the organizational hierarchy of the company (or other organization) for which the budget is to be generated. In any case, in one embodiment, user 144 either accesses an existing budget hierarchy 138, or generates a new budget hierarchy 138. This is indicated by block 160 in FIG. 2. FIG. 2A is a simplified hierarchical diagram showing one exemplary budget hierarchy 162 for budget planning In hierarchy 162, the organization for which budget planning is to be done includes a budget office represented by node 164. Budget office 164 has at least two departments 166 and 168. Each department has one or more divisions 170 and 172 (while only divisions for department 166 are illustrated, there may also be divisions for department 168 as well).

In the embodiment shown in FIG. 2A, division 1 is responsible for three programs represented by nodes 174, 176 and 178. In the hierarchy 162 shown in FIG. 2A, department node 166 is a child (or descendent) of budget office node 164 which is its parent (or ancestor). Division nodes 170 and 172 are children (or descendants) of department node 166 and program nodes 174, 176 and 178 are children (or descendants) of their parent (or ancestor) division node 170.

In one embodiment, each of the nodes in hierarchy 162 may have an associated budget. Therefore, each node may illustratively have a budget plan that is used in generating its corresponding budget. For instance, if an administrator of the program represented by node 174 needs to create a budget to fund that program, then a budget plan can be generated for node 174. Similarly, if the division represented by node 170 needs to create a budget, then a budget plan can be generated for division node 170, that receives inputs from, or distributes information to, the budgets generated for nodes 174, 176 and 178. The same is true of each node in hierarchy 162. For each node, a budget plan is illustratively generated and used in creating a budget. The budgets corresponding to each node can then be rolled up to budget office 164 where they can be aggregated and presented in an overall budget for review and approval. Of course, certain things can be distributed downward from the budget office plan for node 164 to the plans for its descendent nodes, This can be used, for example, when the budget office sets targets for the divisions.

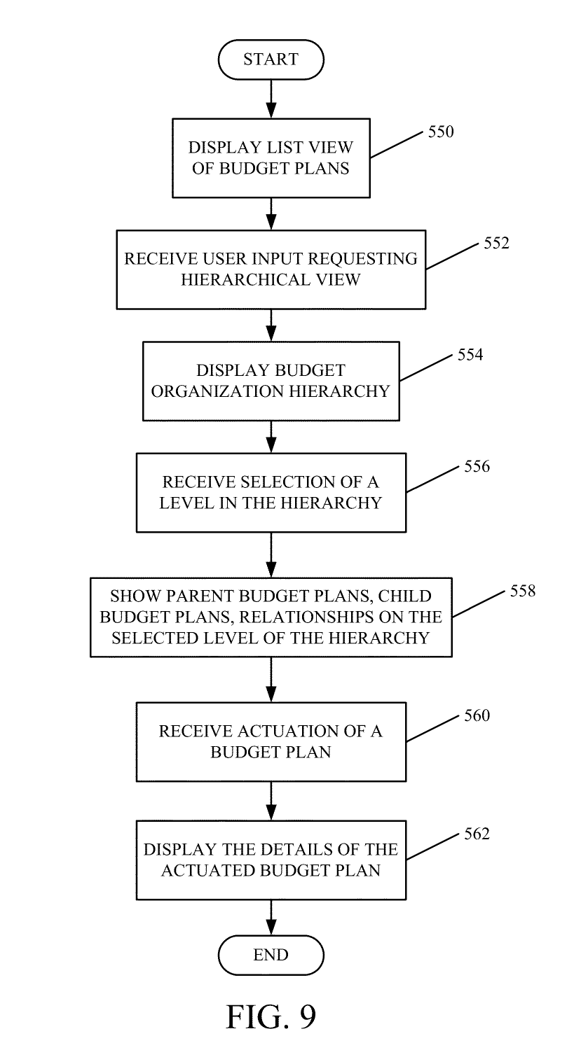

FIG. 2B shows one illustrative user interface display 180 that is generated to show a more complex budget hierarchy 182. As will be described below in more detail with respect to FIG. 9, user 150 can navigate through the various budget plans corresponding to the nodes in hierarchy 182, and corresponding informational displays 184 are changed or updated, as the user selects different nodes in hierarchy 182. This is described in greater detail below with respect to FIGS. 9 and 9A. It is briefly mentioned here for the sake of better understanding the present description.

In any case, once user 144 has either accessed an existing budget hierarchy or generated a new budget hierarchy, then user 144 illustratively generates a budget plan for each desired node in the budget hierarchy. This is indicated by block 186 in FIG. 2. Assuming that each node in the budget hierarchy is to have an associated budget, then a budget plan is generated for each node in the hierarchy.

Once the budget plans are generated for each node in the hierarchy, they can then be associated with one another in child/parent associations to follow the budget hierarchy for which they were generated. FIG. 2C shows one illustrative user interface display 192 that shows a budget plan hierarchy 194. Budget plan hierarchy 194 includes a budget plan that has been generated for each node in the user interface display shown in FIG. 2B. Also, the budget plans in hierarchy 194 are connected to one another in parent/child relationships which correspond to the nodes in user interface 180 in FIG. 2B as well. Associating budget plans with one another in parent/child relationships is indicated by block 196 in FIG. 2. It will be noted that block 196 is shown in dashed lines indicting that it is optional. That is, where only a single budget is to be generated, then only a single budget plan needs to be generated and it does not need to be associated with any other plans. However, the present description will proceed with respect to a plurality of different budget plans being arranged in parent/child relationship.

Once all of the budget plans have been generated, they are saved and output for use by those responsible for generating the budgets corresponding to those budget plans. This is indicated by block 198 in FIG. 2.

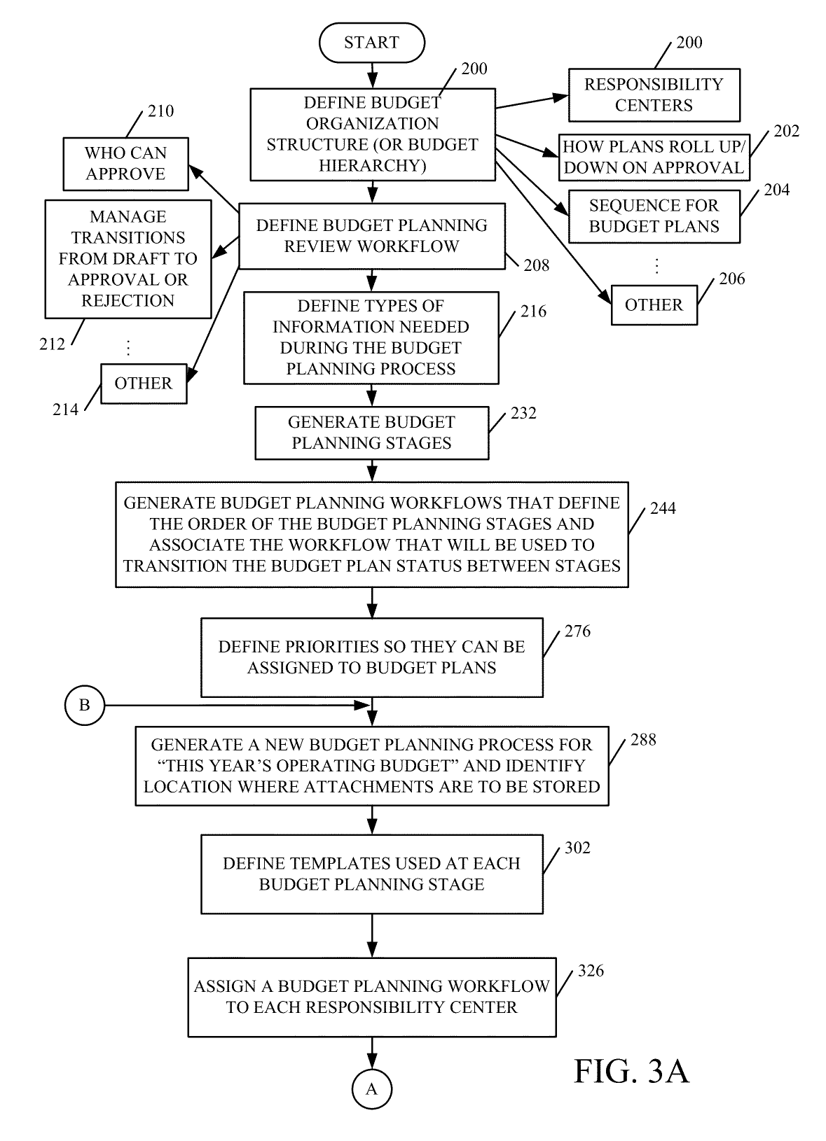

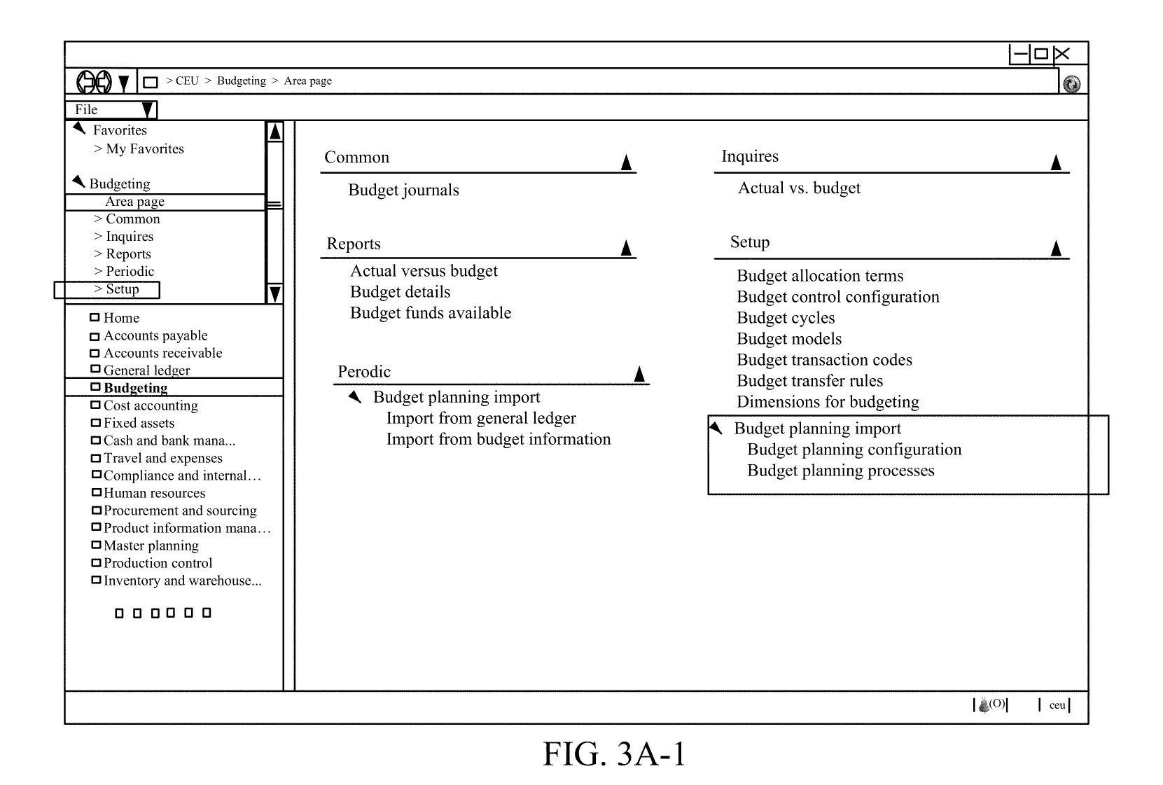

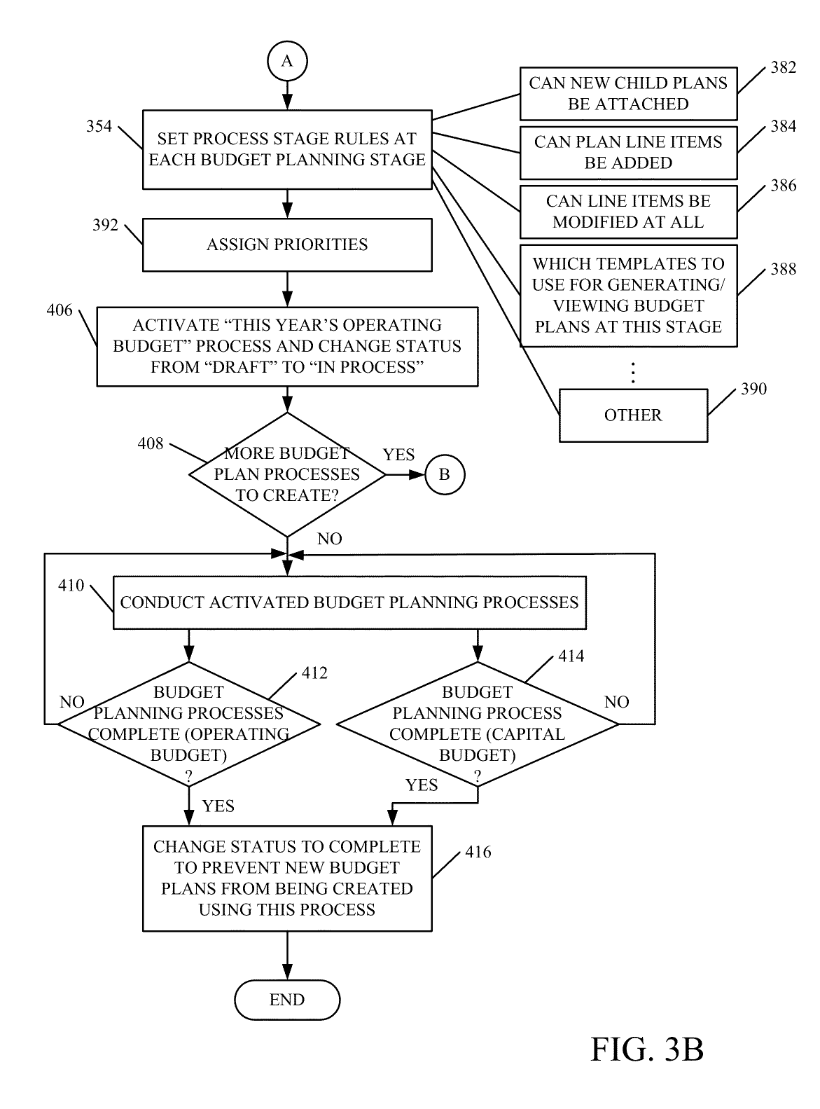

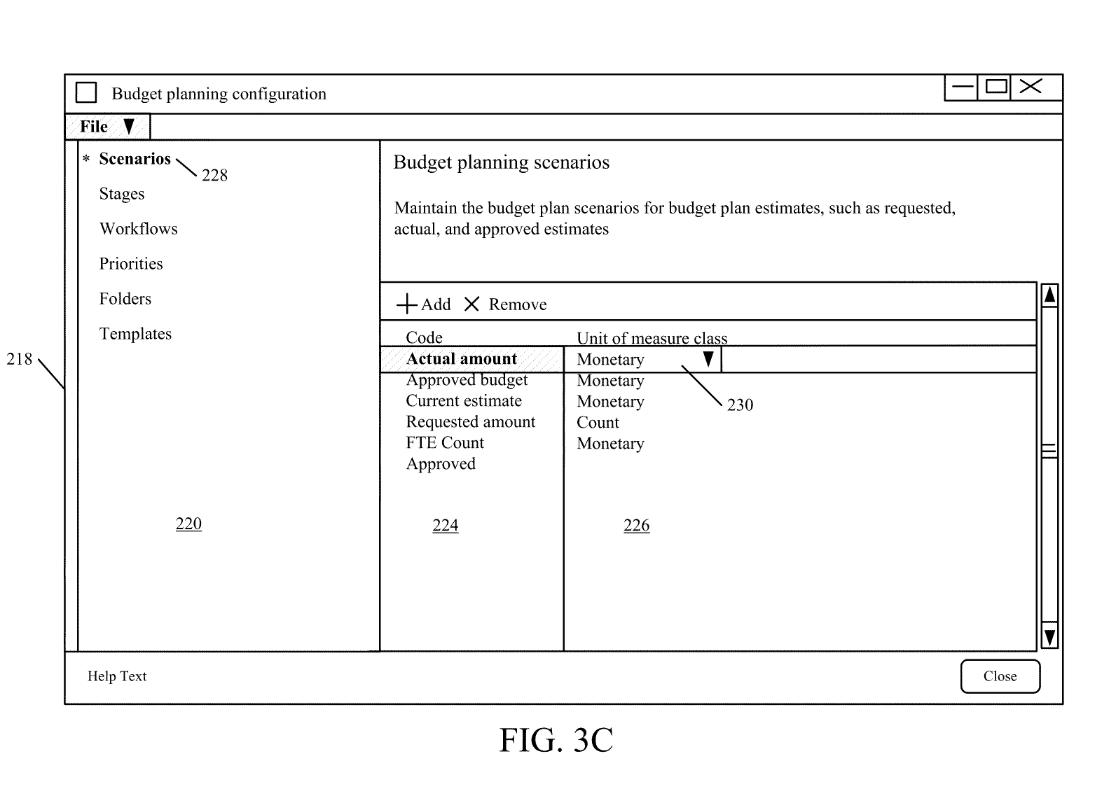

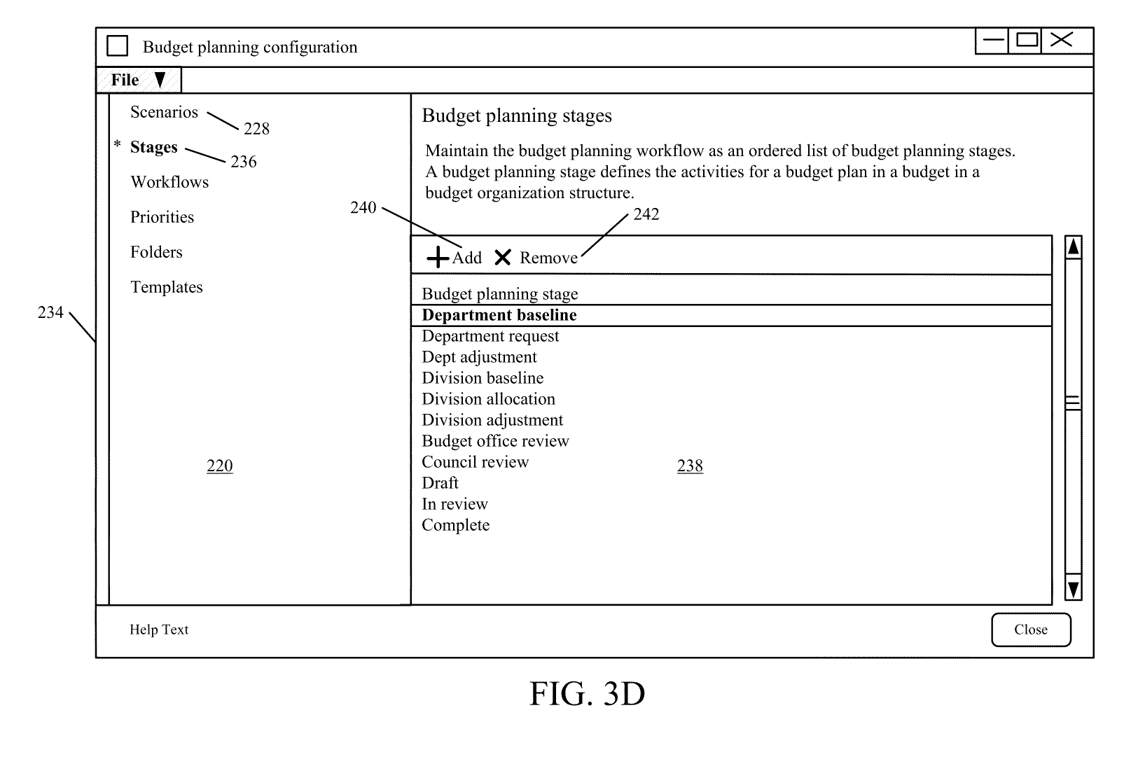

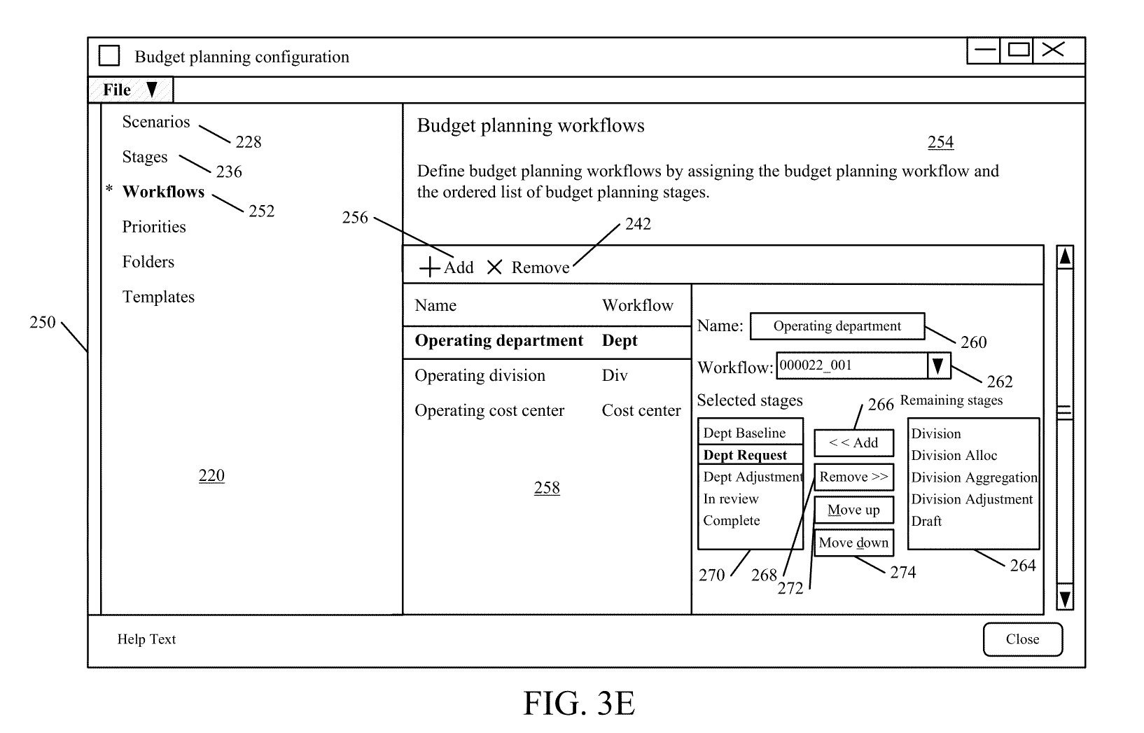

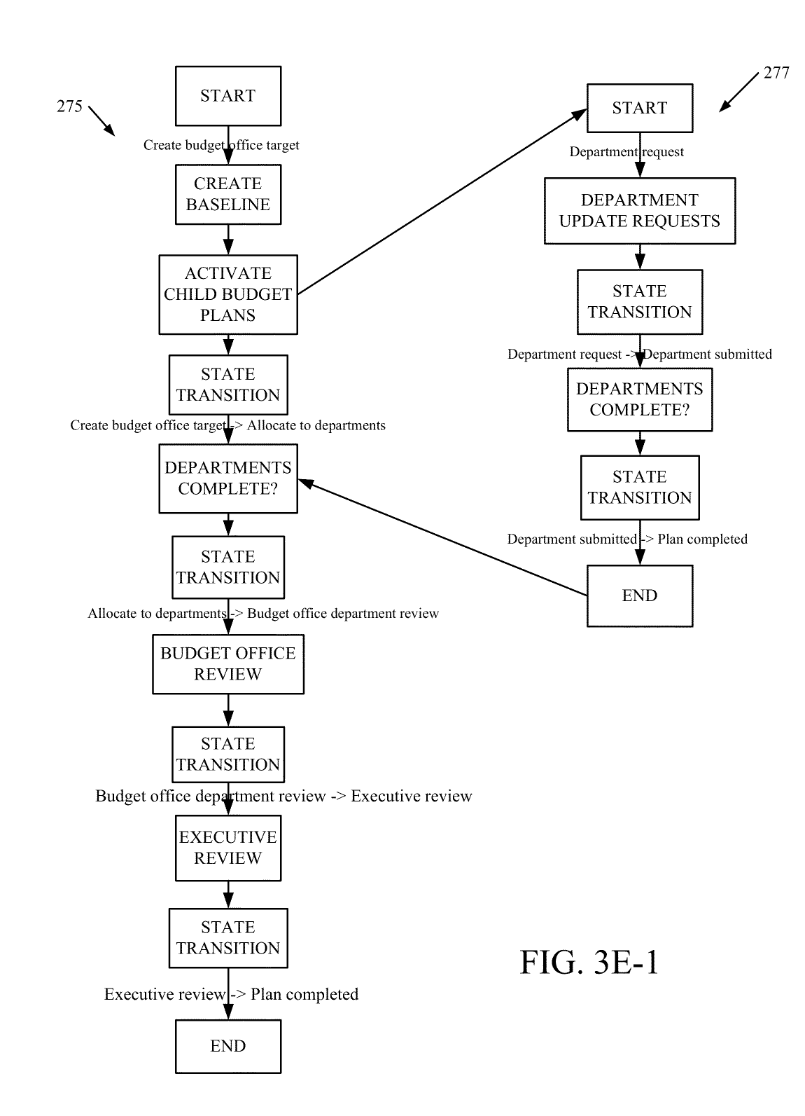

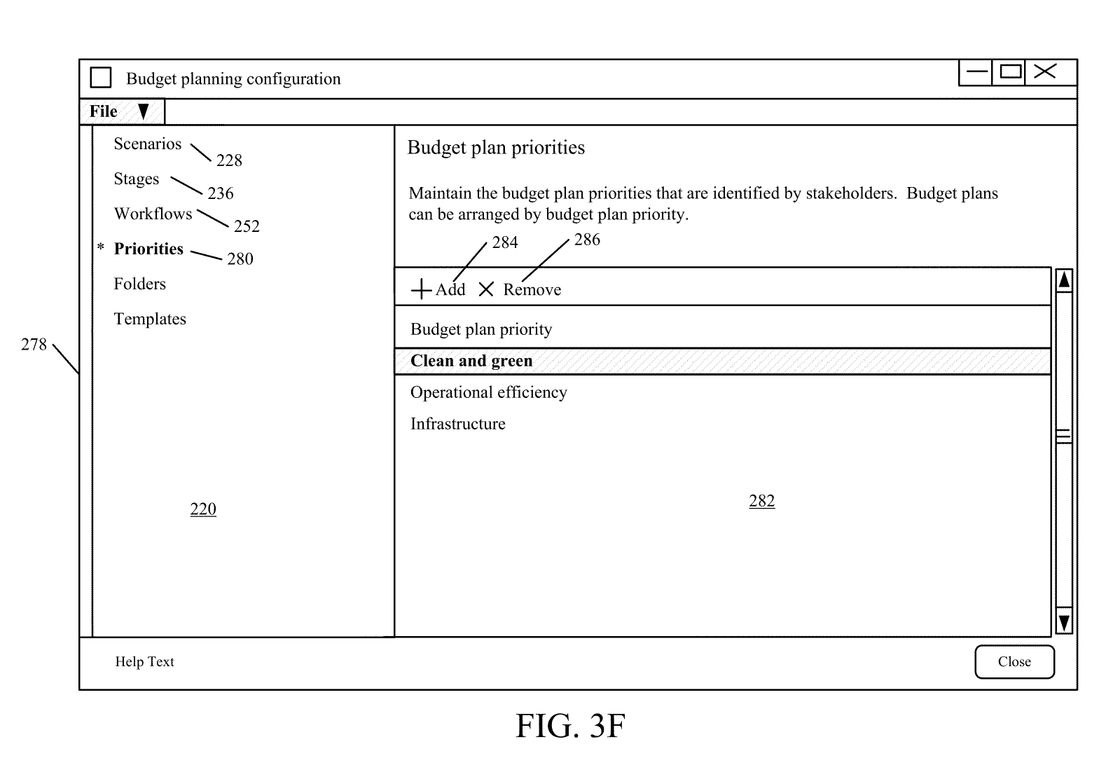

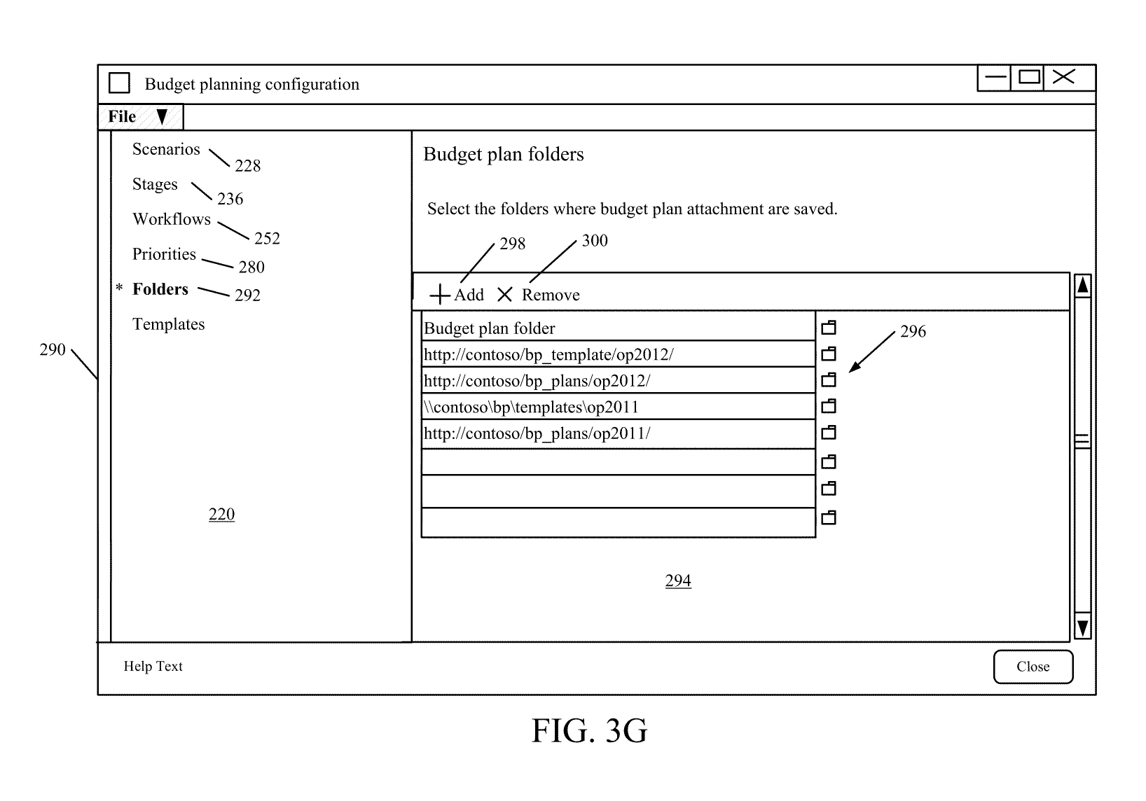

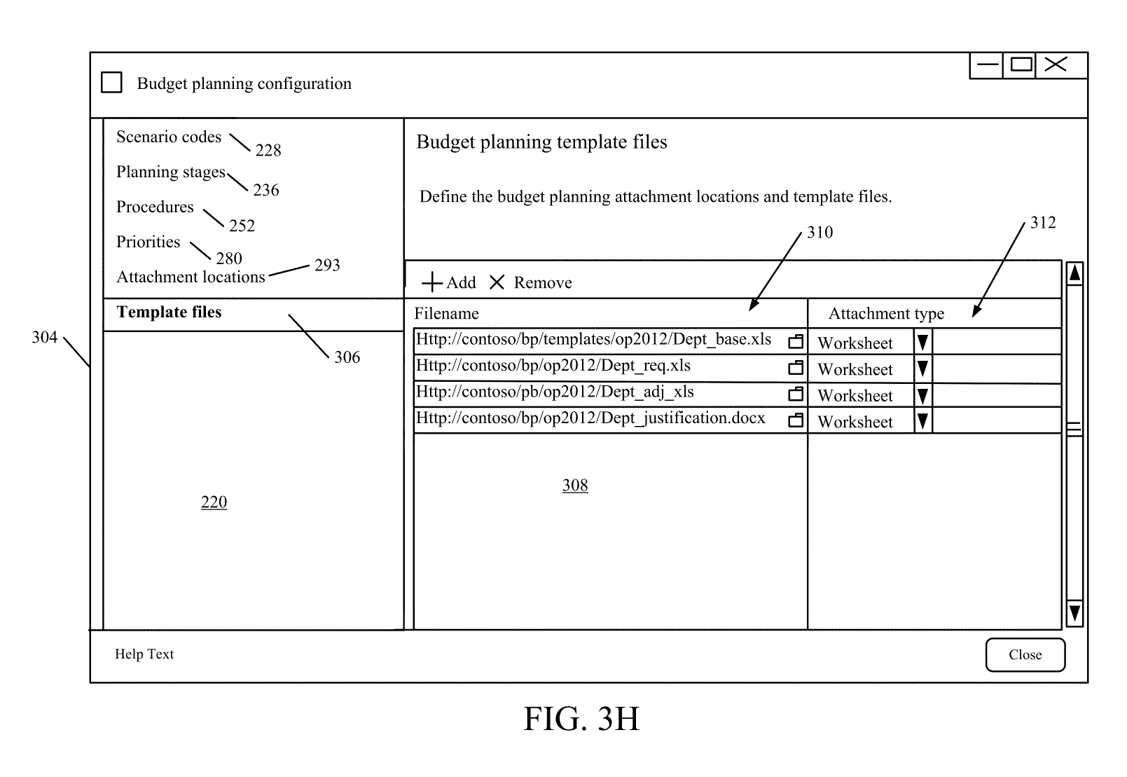

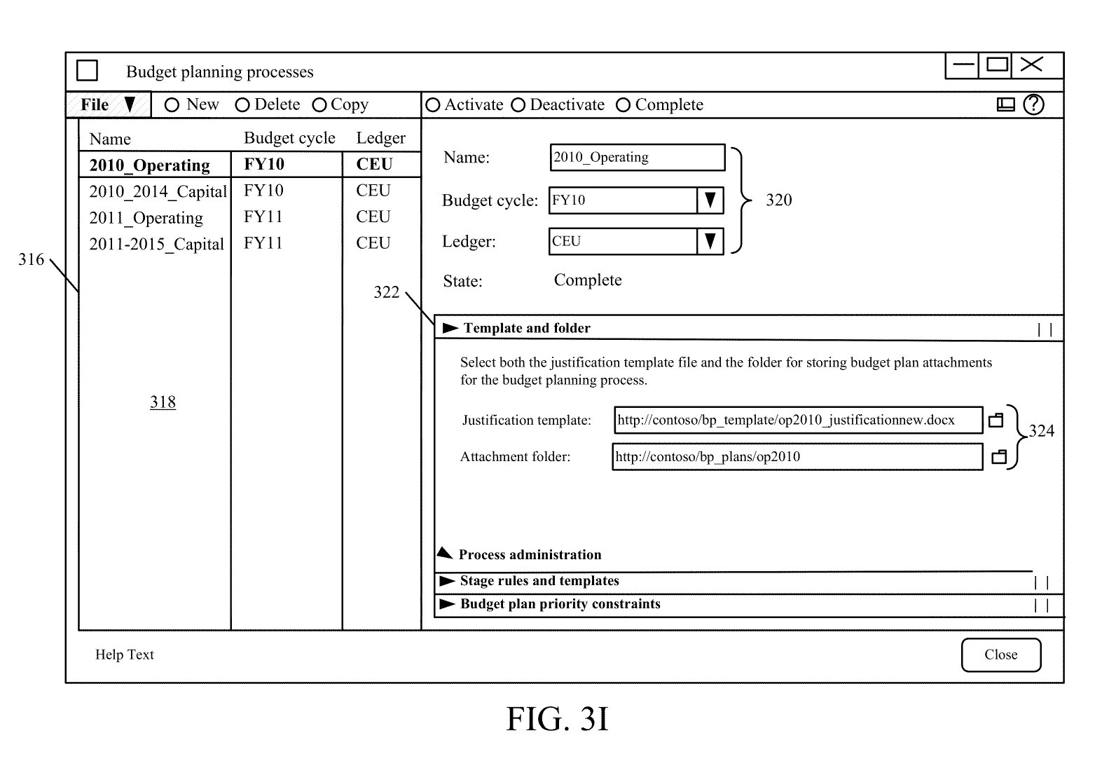

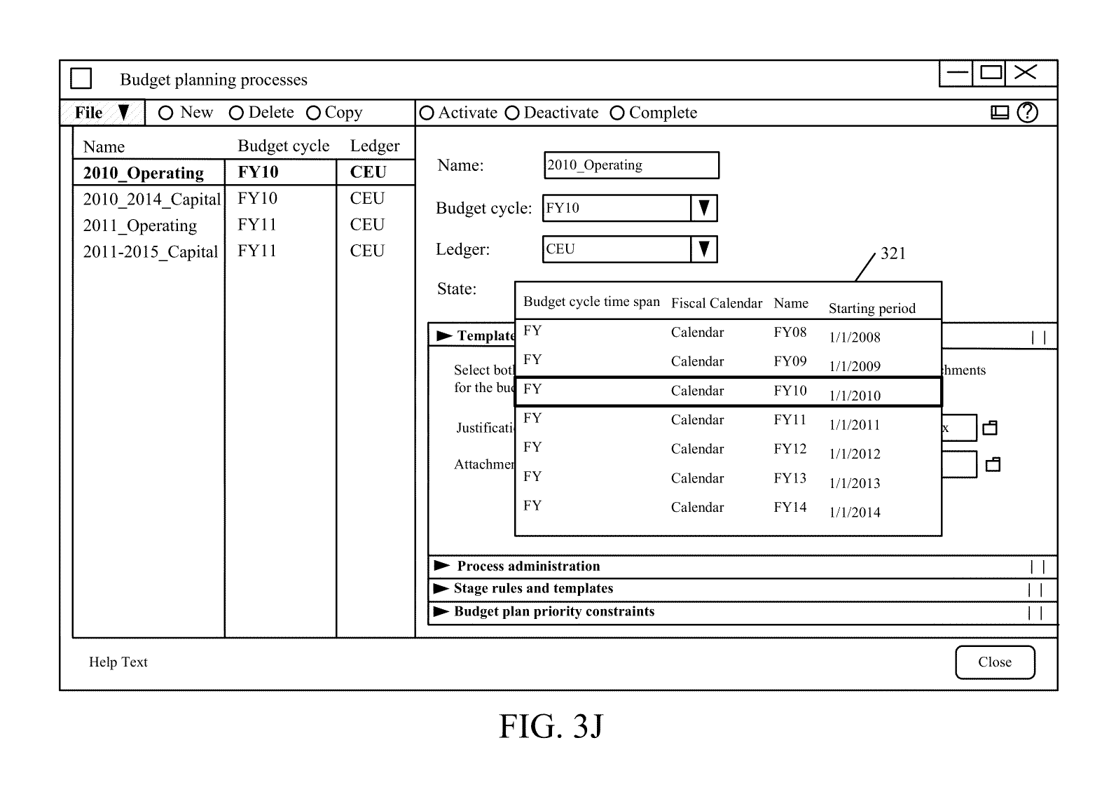

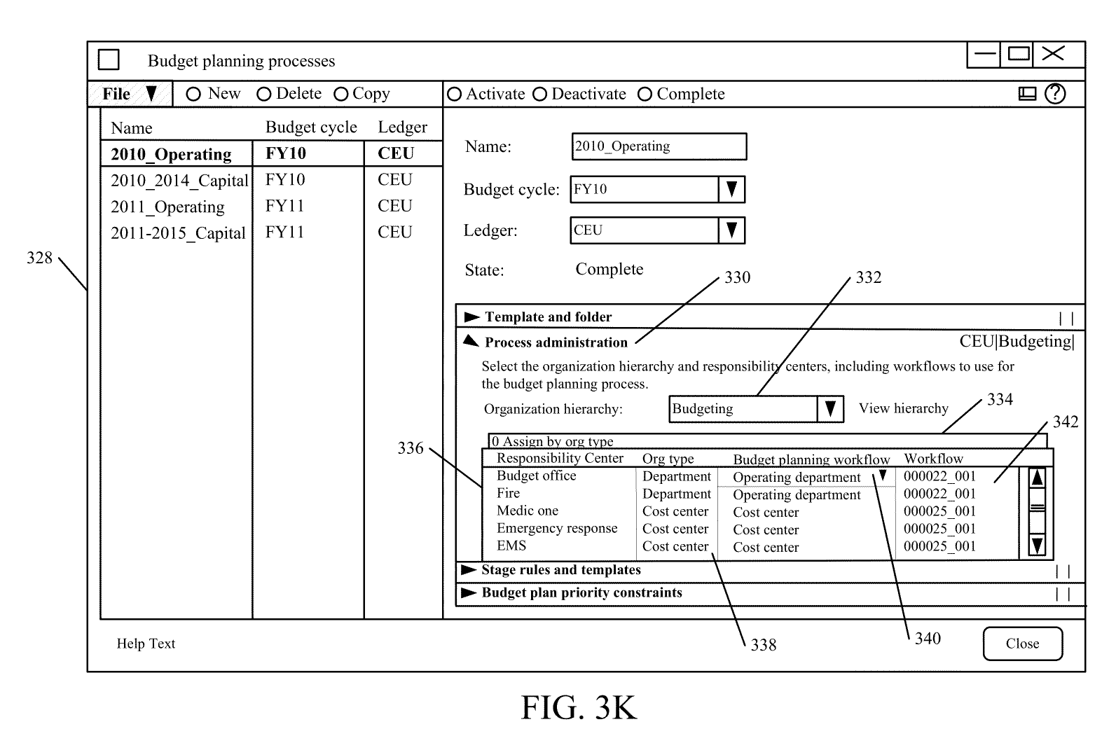

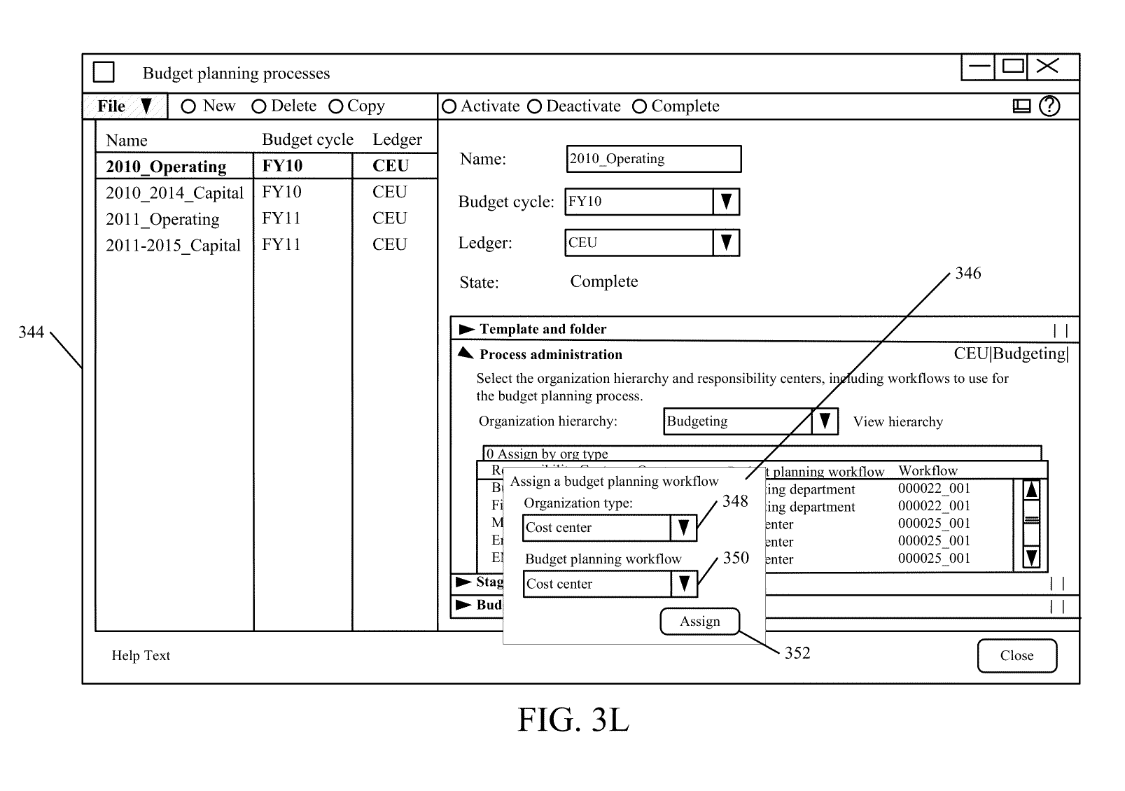

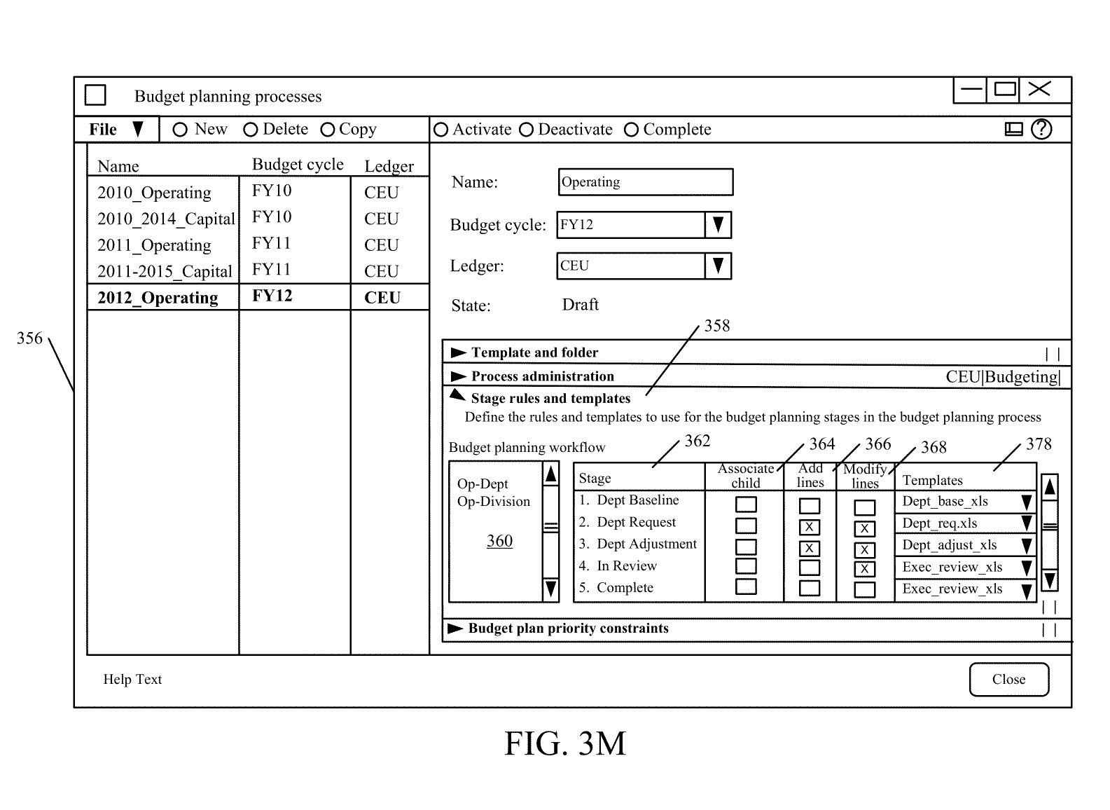

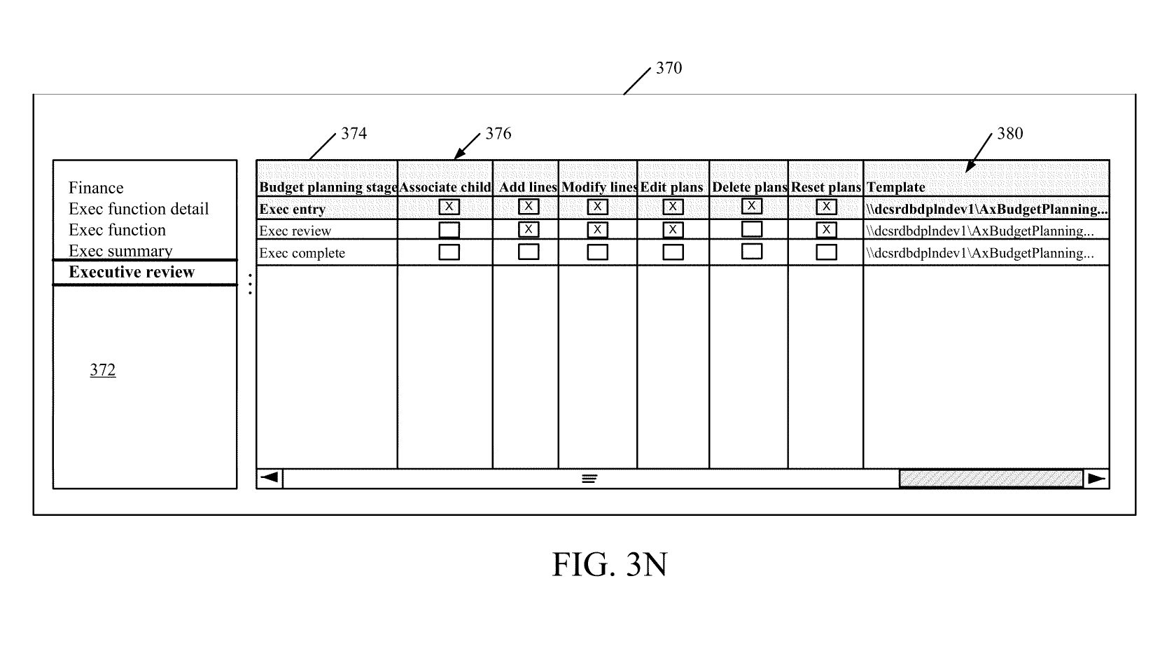

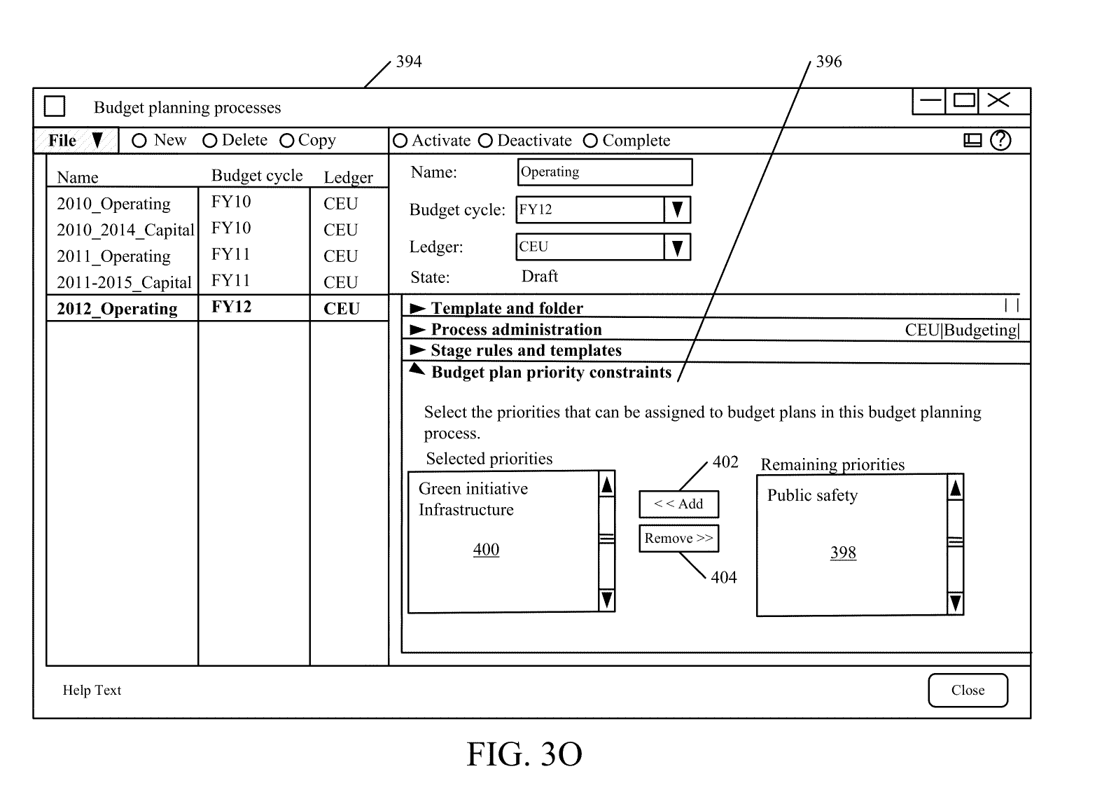

FIGS. 3A and 3B (collectively referred to as FIG. 3) show a flow diagram that illustrates one embodiment of the operation of the system shown in FIG. 1, in generating a budget plan, in more detail. Before beginning this description, it may be helpful to understand a number of terms. A budget planning process is a practice to develop the financial estimates of income and expenses, and inputs and outputs for the budget planning process. A budget plan is a document used to develop estimates of inflows and outflows for a responsibility center.

FIG. 3A-I shows a user interface display that allows the user 144 to enter the budget plan configuration mode to configure items to be used by a budget plan. This is done by selecting the configuration button.

User 144 first uses hierarchy generation component 126 to define a budget organization structure (or budget hierarchy) such as that shown in either FIG. 2A or 2B. This is indicated by block 200 in FIG. 3. In doing so, user 144 interacts with suitable user interface displays 150 to define responsibility centers 200 that are responsible for various budgets. These correspond to the nodes in the budget hierarchy.

User 144 then defines how the budget plans roll up or down within the hierarchy and how they are eventually approved. This is indicated by block 202 in FIG. 3. User 144 then illustratively defines the sequence for the budget plans. That is, some budget plans in the hierarchy will be dependent on others before their corresponding budget can be completed. This dependency (or sequence) is indicated by block 204 in FIG. 3. Of course, user 144 can provide other inputs to define other features in a budget hierarchy as well, and this is indicated by block 206.

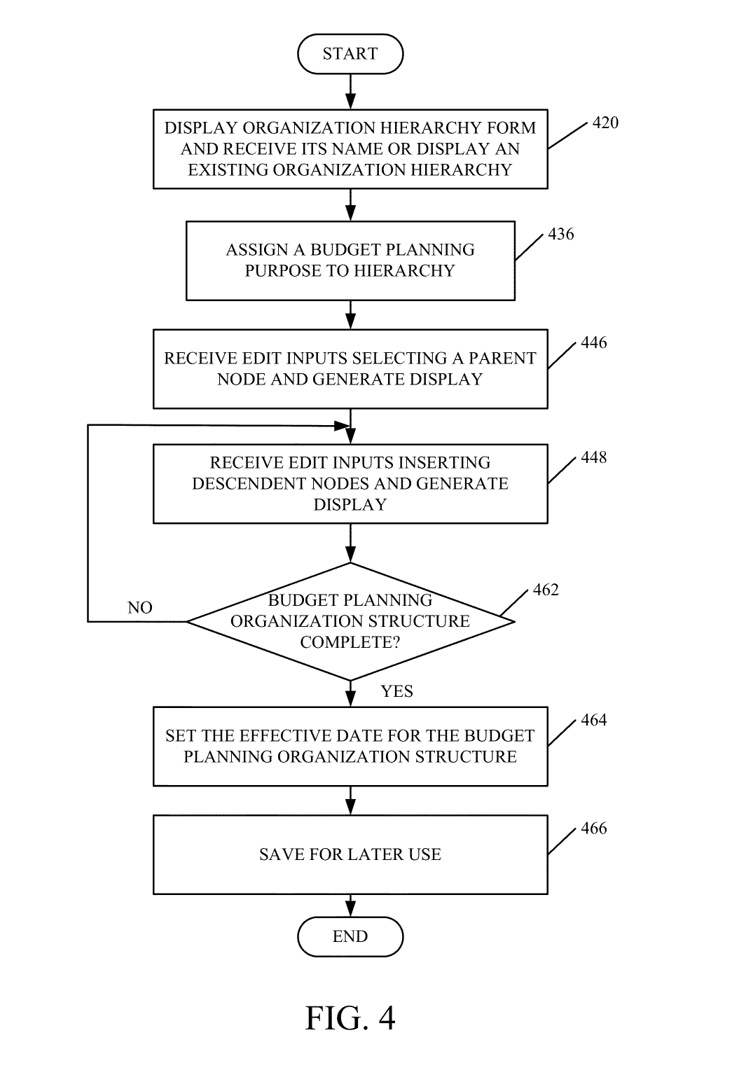

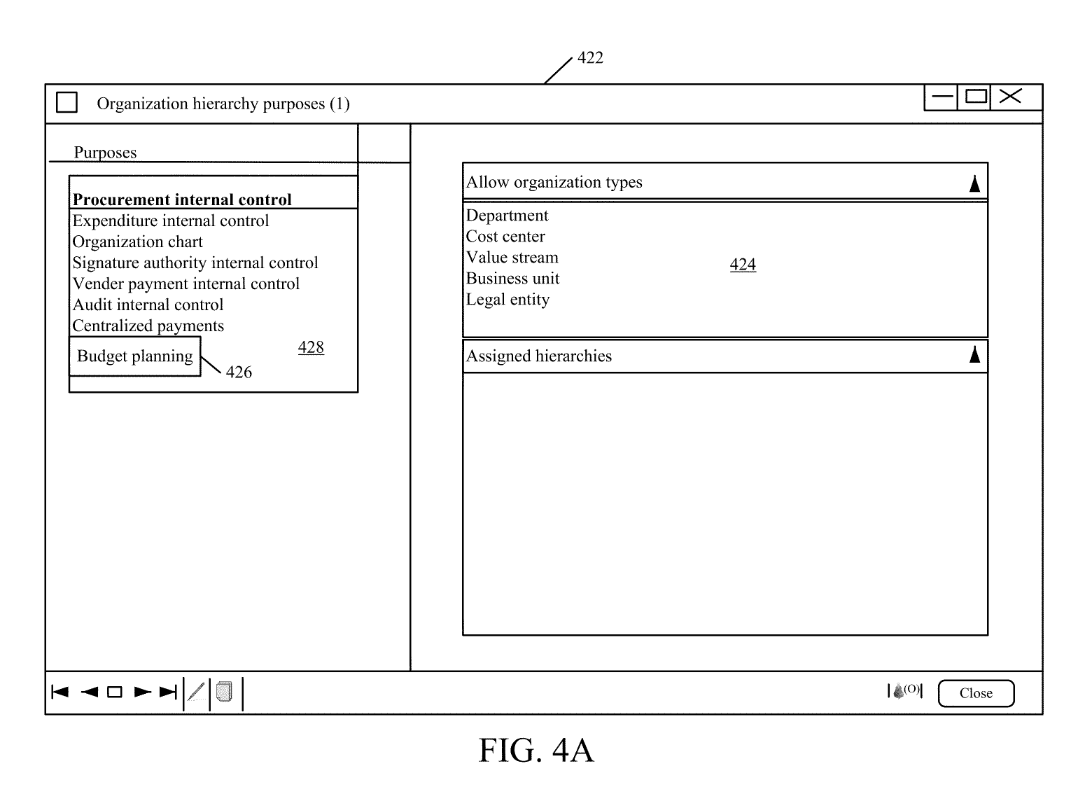

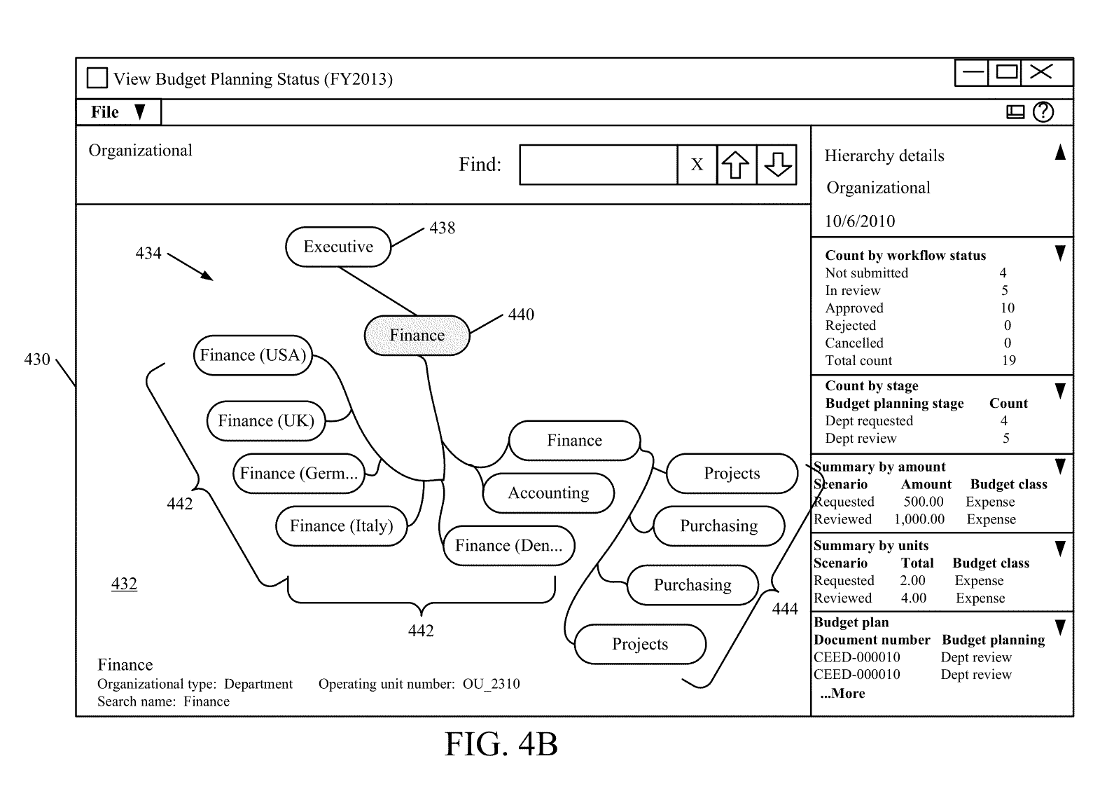

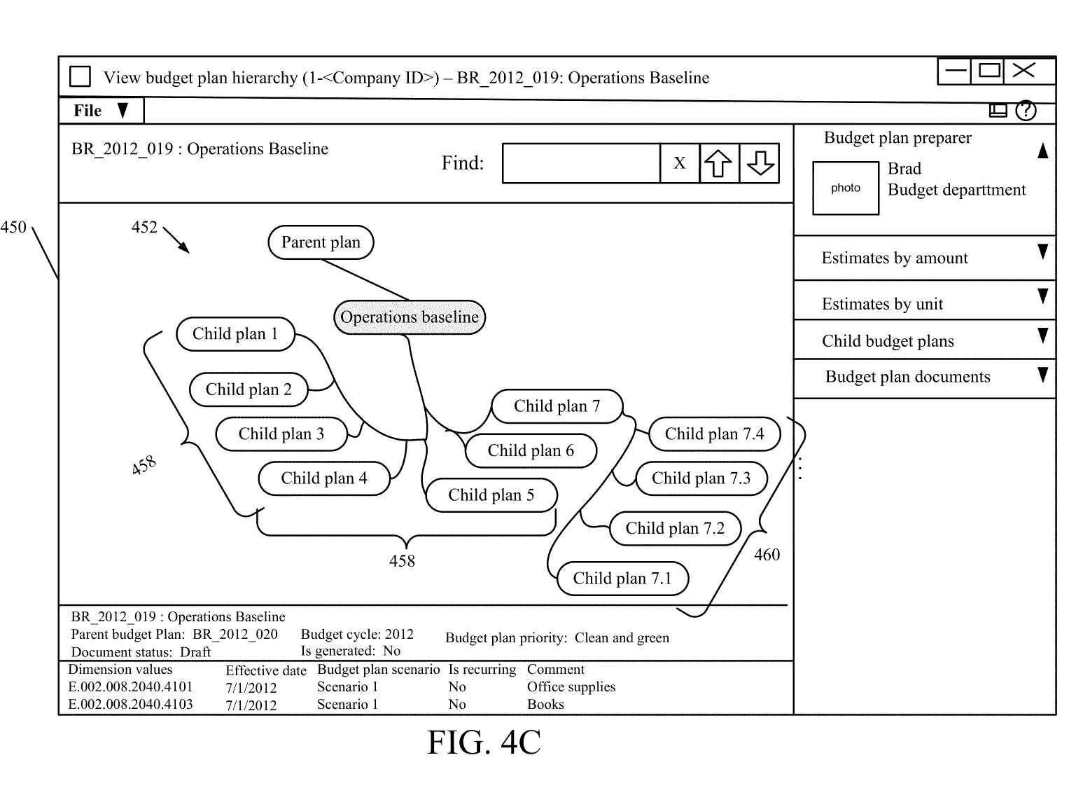

Before continuing with the description of FIG. 3, creating a budget planning hierarchy will be described in more detail. FIG. 4 is a flow diagram illustrating one embodiment of the operation of system 102 (and specifically configuration component 130), in operating to create an organization structure (or budget planning hierarchy) 138 with a budget planning purpose. Hierarchy generation component 126 first displays an organization hierarchy form and receives its name or displays an existing organizational hierarchy. This is indicated by block 420 in FIG. 4. FIG. 4A shows one illustrative user interface display 422 that allows the user to choose an organization type from list 424 and assign a purpose to the organization type, such as “budget planning” by selecting item 426 from a purposes list 428.

In one embodiment, the hierarchy generation component 126 generates a user interface display with a canvas and allows a user to drag and drop various hierarchical organizational components onto the canvas and inter-relate them in a dependency structure (or hierarchy) to form the organization hierarchy. The user interface display also allows the user to name the structure and assign it a budget planning purpose. FIG. 4B shows a user interface display 430 that has a canvas 432 that shows an organizational hierarchy 434 that is to be used for budget planning Assigning the budget planning purpose to the organizational hierarchy is indicated by block 436 in FIG. 4.

It can be seen in FIG. 4B that the user has chosen a parent node labeled “executive” 438 and has associated a child node labeled “finance” 440 as a child of the executive parent node 438. The user has also chosen a plurality of grandchild and great grandchild nodes 442 and 444, respectively, and arranged them hierarchically in structure 434. Receiving these types of edit inputs selecting a parent node and dependent nodes and generating a display of those nodes to display hierarchical structure 434 is indicated by blocks 446 and 448 in FIG. 4, respectively.

Hierarchy generation component 126 then allows the user to identify budget plans related to the hierarchical structure 434, in order to generate a budget plan hierarchy (of budget plans) corresponding to structure 434. FIG. 4C shows a user interface display 450 that shows a budget plan hierarchy 452 that shows a parent budget plan node 454 corresponding to a parent budget plan, a child budget plan node 456 corresponding to a child budget plan and a plurality of children and grandchildren nodes 458 and 460 which correspond to the child and grandchildren nodes 442 and 444 in structure 434, respectively. The budget plan hierarchy and the organization hierarchy, once complete, can have an effective date set for the budget plans corresponding to those hierarchies. This is indicated by blocks 462 and 464 in FIG. 4. The budget hierarchy and organizational structure can then be saved for later use, in budget planning data store 134, or in other data stores. This is indicated by block 466 in FIG. 4.

Referring again to FIG. 3, once the budget hierarchy is defined at block 200, user 144 uses hierarchy generation component 126 to also define the review workflow for review of a budget in the corresponding budget plan. This is indicated by block 208 in FIG. 3. This illustratively includes a definition of who can approve the budget as indicated by block 210, and it also allows user 144 to define and manage transitions in the budget planning process. For instance, the budget, as it is being drafted, may be in a “draft” status, and then it may be transferred to a “review” status where it is being reviewed. Of course, once it is finally approved or rejected, it can be transferred to an approved or rejected state as well. Managing these transitions is indicated by block 212 in FIG. 3. Of course, the user can also define other review workflow items, and this is indicated by block 214.

Once the user 144 has generated the budget hierarchy, the user can then define types of information needed during the budget planning process. In one embodiment, user 144 accesses budget planning component 128 (and specifically configuration component 130) to set up the types of information needed during the budget planning process. In order to do this, user interface component 136 illustratively generates suitable user interface displays 150 that allow the user to set up this type of information. In one embodiment, user 144 first defines budget plan scenarios. A budget plan scenario, for the purposes of the present description, is a classification of budget plan line item estimates for budget planning A budget plan scenario allows an organization to track budget amounts or quantities. Some examples of budget plan scenarios include “requested”, “actuals”, and “approved”. Defining the types of information needed in terms of budget plan scenarios is indicated by block 216 in FIG. 3.

FIG. 3C shows one exemplary user interface display 218 that can be generated by configuration component 130 (using user interface component 136) through which user 144 can define budget plan scenarios. It can be seen that user interface display 218 illustratively includes a list section 220, a code section 224, and a unit of measure section 226. When user 144 selects the scenarios entry 228 in the list in section 220, code section 224 displays a list of scenarios and unit of measure section 226 displays dropdown menu 230 which can be actuated by the user to select one of a variety of different units of measure corresponding to a selected scenario in list 224. In FIG. 3C, it can be seen that the user has selected the “actual amount” scenario and has selected the unit of measure as “monetary” in dropdown menu 230. Again, the user is simply setting up the different types of inputs that will be needed in a budget using the budget plan that the user 144 is currently generating. In this example, one type of information that will be needed is an “actual amount” and it will be given in monetary terms.

It can be seen that list 224 includes a variety of other scenarios including an “approved budget” scenario which will be given in monetary terms, a “current estimate” scenario which is given in monetary terms, a “requested amount” scenario which is given in monetary terms, a “FTE” amount (which refers to a full time equivalent count meaning the number of full time equivalent employees) which is measured as a simple count, and an “approved” scenario which is given in monetary terms as well.

Once the user has defined all the types of information (such as all the scenarios), then the user illustratively generates the various budget planning stages that will be used in the budget plan. This is indicated by block 232 in FIG. 2. A budget planning stage, for purposes of the present description, describes the transitions of a budget plan in a budget planning process and responsibility center. For example, a budget planning process may go through a variety of budget planning stages before it is approved. A budget baseline stage, for instance, is a stage where all of the baseline information is entered into the budget document. The budget document then may go through an “existing programs” stage where all of the existing programs provide their budgetary information. It then may go through a “new programs” stage where new programs of the organization provide budgetary information as well. Of course, it may go through a “request” stage where the budget that has been developed is submitted as a request for approval. After that, there may be an “adjustment” stage where the budgetary information is adjusted during the review process. Similarly, where the budget is a child of a parent budget, there may be an “aggregation” stage where information from all of the children of a parent is aggregated to the parent budget. This would occur in a bottom-up model. In a top-down model, information from a parent budget (such as budgetary targets) may be distributed downward to child budgets. All of these can be stages in the budget planning process.

FIG. 3D shows one exemplary user interface display 234 that can be generated by configuration component 130 (using user interface component 136) that allows user 144 to define the budget planning stages. It can be seen that some of the items in user interface display 234 are similar to those shown in user interface display 218 and they are similarly numbered. However, it can be seen that in FIG. 3D, the user has selected the “stages” items 236 in list section 20. This causes budget planning component 128 to generate a list of stages 238 that can be selected by the user. If the user highlights a stage in the list, and actuates the “add” button 240, that stage will be added to the current budget plan. Of course, the stage can be removed by actuating button 242 as well.

Once the budget planning stages have been defined, user 144 illustratively interacts with process generator 132 in budget planning component 128 to generate budget planning workflows. For the purposes of the present discussion, a budget planning workflow is a sequence of budget planning stages through which the budget plans are passed during the budget planning process. That is, the workflows define the order of the budget planning stages and associate the workflow that will be used to transition the budget plan status between those stages. This is indicated by block 244 in FIG. 3.

FIG. 3E show one exemplary user interface display 250 which is similar, in some ways, to user interface display 234 shown in FIG. 3D. However, FIG. 3E shows that, in list section 220, the user has selected workflows button 252. Budget planning workflow pane 254 is then opened for the user to order the stages according to a desired workflow. In one embodiment, the user can add a name for a given workflow by clicking add button 256 and entering a new name and workflow in box 258. The user can then select one of the workflows in name box 260 and can select a specific workflow, by number, in dropdown menu 262. When this is done, budget planning component 128, and specifically process generator 132, displays a list of stages in stage list 264, that have already been defined by the user. The user can then click the add, and remove buttons 266 and 268, respectively, to add stages from list 264 to selected stages list 270. In this way, the user is selecting particular stages that are to be included in the present workflow.

The user can rearrange the stages in a variety of different ways. In one embodiment, the user simply selects one of the stages in list 270, and clicks the move up button 272 to move the stage upward in the list of selected stages. Similarly, by clicking the move down button 274, the user can move the selected stage downward in the list of selected stages.

In another embodiment, the user can use a workflow editor to arrange stages according to a given workflow. FIG. 3E-1 shows a first workflow 275 that corresponds to a parent budget plan and a second workflow 277 that corresponds to one or more child budget plans. It can be seen that workflow 275 has stages and state transitions. The same is true of workflow 277. Workflow 275 first has a stage for creating a baseline budget and then for activating child budget plans. Once these stages have been processed, there is a stage transition from a state of “Creating Budget Office Target” to a state of “Allocate to Departments”. Workflow 275 then waits for the departments' budget plans to be completed and then undergoes another state transition from “Allocate to Departments” to “Budget Office Department Review”. This means that all of the departments have submitted their budgets and they are awaiting budget office review. Once the budget office review stage is complete, workflow 275 undergoes another state transition from “Budget Office Department Review” to “Executive Review”. When the executive review stage is complete, the workflow 275 goes through another state transition from “Executive Review” to “Plan Completed”.

Workflow 277 shows one illustrative work flow for a child budget plan that starts with a request for the budget document from the department which initiates workflow 277. The first stage is “Department Update Requests” which ask for budgetary updates from the departments. When this stage is completed, workflow 277 goes through a state transition from “Department Request” to “Department Submitted”. When all of the departments have completed their budget plans, another state transition occurs from “Department Submitted ” to “Plan Completed”. Workflow 277 then returns to the “Departments Complete” stage in workflow 275.

The workflows shown in FIG. 3E-1 can be created from an editor that displays a workflow pane and a set of workflow elements (such as stages, transitions, etc.) that can be dragged from an elements pane to the workflow pane and configured as shown in FIG. 3E-1. Of course, other embodiments for generating a workflow can be used as well.

In any case, once the user has finished arranging the stages according to a workflow, the user has successfully generated the budget planning workflow by defining the order of the budget planning stages and associating the workflow that will be used to transition the budget plan status between those stages.

The user can then assign the present budget plan a priority. Budget plan priorities are categories of precedence or areas of importance by which plans are classified for evaluation and ranking. A user can define priorities, and then assign them to a given budget plan. Defining priorities so that they can be assigned to budget plans is indicated by block 276 in FIG. 3. FIG. 3F shows a user interface display 278 that is similar to user interface display 250 shown in FIG. 3E. However, FIG. 3F shows that the user has chosen the priorities button 280 in section 220. This causes budget planning component 128 to open pane 282 which allows the user to add or remove budget plan priorities. In one embodiment, the priorities can be sorted alphabetically, or otherwise. In addition, by clicking the add and remove buttons 284 and 286, the user can illustratively define and add new budget priorities or remove other budget priorities.

Having defined all these things (the organization structure or budget hierarchy, the new workflow, the types of information needed, the budget planning stages, the workflows that arrange the budget planning stages in order, and the priorities), the user can now generate a new budget planning process for a given budget (such as the present year's budget plan). In doing so, the user may wish to identify a location where the budget attachments are to be stored. This is indicated by block 288 in FIG. 3. FIG. 3G shows a user interface display 290, which is similar to user interface display 278 shown in FIG. 3F, except that the user has chosen folders button 292 in display portion 220. This causes budget planning component 128 to open a budget plan folders pane 294. Pane 294 displays a list of folder locations 296 that can be selected by the user. Of course, the user can add or remove other folder locations by using the add and remove buttons 298 and 300.

The user can then define the templates that are used at each budget planning stage, to receive information. This is indicated by block 302 in FIG. 3. FIG. 3H shows another user interface display 304, that is similar to the one shown in FIG. 3G, except that the user has now selected the template files button 306 in portion 220. It can also be seen that the “folders” button 292 has been relabled to “attachment locations” button 293. In any case, this causes budget planning component 128 to open template files pane 308. Pane 308 allows the user to identify the particular file name (by path name or otherwise) in file name list 310, and then to specify the type of template or attachment that is located there in attachment type list 312. In the embodiment shown, list 312 is a set of dropdown menus that allows the user to select from a list of different attachment types for the specific template files listed in list 310.

Having now configured the various items necessary for a budget planning process, the user can then return to the user interface display shown in FIG. 3A-1. Instead of selecting budget planning configuration button under the setup menu, the user can select budget planning processes button. In response, process generator 132 can then generate a user interface display such as that shown at 316 in FIG. 3I. User interface display 316 includes a budget list 318 that lists various budgets that have already been named. By selecting one of those budgets, a user can further define the budget using the budget cycle and dropdown menus in section 320. The user can then select a number of different tabs and further define the process. In the embodiment shown in FIG. 3I, the user has selected the template and folder tab 322. This display allows the user to select a template file and a folder for storing budget plan attachments for the budget planning process. This can be done through suitable user input mechanisms, such as text boxes or dropdown menus, one example of which is shown at block 324.

FIG. 3J shows one example where the user wishes to further configure the budget by selecting the dropdown menu for the budget cycle in portion 320. It can be seen that this allows the user to select the budget cycle span, the fiscal calendar, the name and the starting period for the present budget process. This is indicated in menu portion 321.

The user can then assign a budget planning workflow to each responsibility center. This is indicated by block 326 in FIG. 3. FIG. 3K shows one example of a user interface display 328, which allows the user to do this. In FIG. 3K, the user has selected the process administration tab 330. This allows the user to select the budgeting hierarchy in dropdown menu 332. This results in the display for assigning budget planning workflow to a responsibility center. This can be done in menu 334. It can be seen that menu 334 allows the user to select one of the responsibility centers in section 336 and either define or view the organization type in section 338. The user can then use a suitable user input mechanism, such as dropdown menu 340, to assign a budget planning workflow to the selected responsibility center. Menu 334 also shows that the workflow number is displayed in portion 342.

FIG. 3L shows another user interface display 344. In one embodiment, the user has selected one of the responsibility centers. This causes menu 346 to be displayed. Menu 346 includes dropdown menu 348 and dropdown menu 350 that allow the user to select an organization type and budget planning workflow, respectively. The user can then actuate the “assign” button 352 to assign the workflow and organization type to that responsibility center.

Having assigned a budget planning workflow to each responsibility center, the user can now set process stage rules at each budget planning stage in a given workflow. This is indicated by block 354 in FIG. 3. FIG. 3M shows one illustrative user interface display 356 that can be generated for doing this. It can be seen that user interface display 356 is similar to user interface display 344 shown in FIG. 3L, except that the user has now selected the stage rules and templates button 358. This causes budget planning component 128 to generate a list 360 of budget planning workflows, and another user interface 362 that identifies various stages in the selected workflow, and a set of rules 364, 366 and 368 that can be configured for a selected stage in list 362. In one embodiment, rule 364 allows the user to associate a child budget plan with the current budget plan that is being configured. Rule 366 allows a user to add lines to the current budget plan, while rule 368 allows the user to modify lines in the current budget. In one embodiment, the user sets rules for each of the stages in stage list 362 by placing a check in the check box associated with each of the rules. Therefore, as shown in FIG. 3M, the stage “department request” has been configured so that a user can add lines to the budget in that stage of the budget plan and modify lines as well.

Of course, other user interface displays can be used as well. FIG. 3N, for instance, shows another user interface display 370 that can be used to define the rules and templates used for the budget planning stages in a selected budget planning process. The user selects a workflow from workflow list 372, and then selects a stage from stage list 374. As workflow list 372 is selected, stage list 374 is updated. As a stage from list 374 is selected, the displayed rules are updated as well Finally, the user selects rules that are enabled at a selected stage by using the rules generally shown at 376. In the embodiment shown in FIG. 3N, the user can associate a child, add lines, modify lines, edit a budget plan, delete a budget plan, or reset a budget plan, as configured by the user.

Both FIGS. 3M and 3N allow the user to also assign templates to be used for generating or viewing budget plans at a selected stage. In FIG. 3M, this is done by the user selecting a dropdown menu 378 and selecting a template for use in entering information at that budget planning stage. The same is true in FIG. 3N, where the user selects a dropdown menu 380 and selects a template for receiving budget information at the selected stage. Of course, this can be done in other ways as well.

In any case, FIG. 3 shows that setting the process stage rules can include attaching child plans, as indicated by block 382, adding line items as indicated by block 384, modifying line items as indicated by block 386 and assigning templates as indicated by block 388. Of course, the user can configure other rules at each stage as well, and this is indicated by block 390.

The user can then assign priorities to the budget plan, before activating it. This is indicated by block 392 in FIG. 3. FIG. 30 shows one exemplary user interface display 394 that can be used by the user to assign priorities to a budget plan. User interface display 394 is similar to user interface display 356 shown in FIG. 3M, except that the user has now selected the “budget plan priority constraints” button 396. This causes user interface display of user input mechanisms that show a list of priorities in field 398 and a list of selected priorities in field 400. By actuating add button 402 or remove button 404, priorities are assigned from list 398 to the budget plan in list 400 or they are removed from the budget plan in list 400 to the priorities list 398, respectively.

Once the priorities are assigned to a budget plan, the budget plan can be activated by the user. This can be done by actuating the “activate” button 406 on user interface display 394. This changes the status of the budget from “draft” to “in process”. Budget plans can now be created using this budget planning process, once it has been activated. Activating the budget planning process is indicated by block 406 in FIG. 3. Budget planning component 128 then determines whether there are any more budget planning processes that need to be created. If so, processing reverts back to block 288 and additional budget planning processes can be created for the budget hierarchy that was previously configured. Determining whether more budget planning processes are to be created is indicated by block 408 in FIG. 3.

Once all of the budget planning processes have been created, then budget planning system 102 allows the various users involved to conduct budget planning using the activated budget planning process. In doing so, the system guides the budget planning process through the various stages in the various workflows until the entire budget planning process is complete. Budget planning system 102 can do this for a plurality of different budgets at a given time. For instance, system 102 can perform these steps for an operating budget and for a capital budget, as discussed above. Conducting the budget planning process and completing the various budgets is indicted by blocks 410, 412 and 414 in FIG. 3. Once the budget has been completed, the status of the given budget is changed to “complete” in order to prevent new budget plans from being created using this process. Changing the status is indicated by block 416 in FIG. 3.

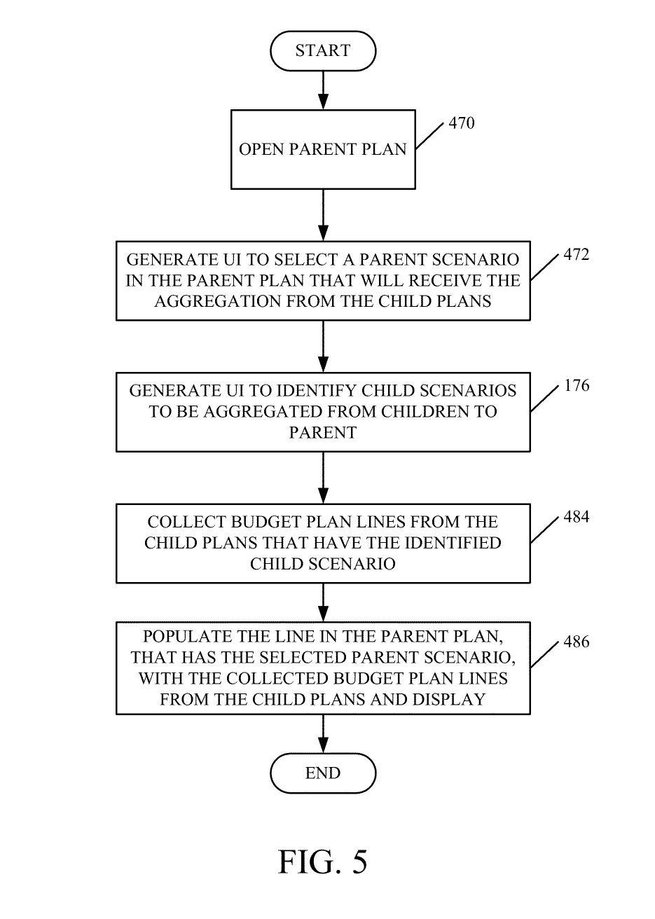

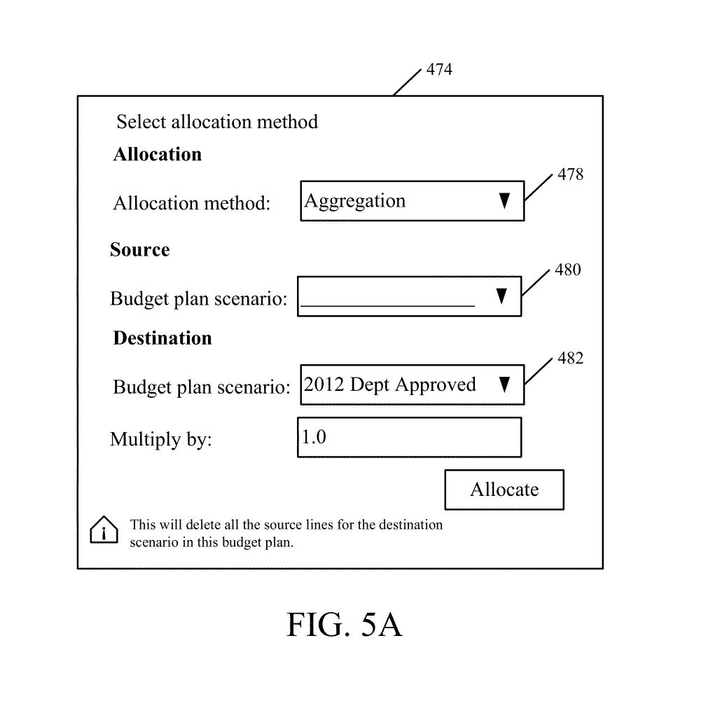

FIG. 5 is a flow diagram illustrating one embodiment of the operation of budget planning component 128 generating a budget plan that aggregates child plans into a parent plan. In one embodiment, the user first opens a parent plan that is to receive aggregations from child plans. This is indicated by block 470 in FIG. 5.

Configuration component 130 then generates a user interface display to allow a user to select a parent scenario in the parent plan that will receive the aggregation from one or more child plans. This is indicated by block 472 in FIG. 5. FIG. 5A shows one embodiment of a user interface display 474 that allows the user to define the parent scenario in the parent plan that is to receive the aggregation. User interface display 474 further allows the user to identify child scenarios to be aggregated from child plans to the identified parent scenario. This is indicated by block 476 in FIG. 5. For instance, the user using dropdown menu 478 can define that the user wishes to have an allocation from a source budget plan scenario (that can be chosen in dropdown menu 480) to a destination budget plan scenario (that can be chosen from dropdown menu 482).

In fact, multiple source scenarios can be used and aggregated to a single destination scenario in the parent plan. Table 1 illustrates an example where multiple source lines are to create a single destination budget plan line. The upper portion of Table 1 shows the dimensions, effective date, budget class and amount that are used as the source lines to generate the aggregated line in the parent plan. Collecting the budget plan lines from the child plans that have the identified child scenario is indicated by block 484 in FIG. 5. Using that information to populate the line in the parent plan, that has the selected parent scenario, and displaying that information is indicated by block 486 in FIG. 5.

TABLE 1

| | | | |
|---|---|---|---|
| Dimension | Effective Date | Budget class | Amount |

For example:

| | | | |
|---|---|---|---|
| 100.10.01 | Dec. 22, 2010 | Expense | 100.00 |
| 100.10.01 | Dec. 22, 2010 | Expense | 200.00 |

Would be aggregated

| | | | |
|---|---|---|---|
| 100.10.01 | Dec. 22, 2010 | Expense | 300.00 |

But the following would not as the budget classes are different.

| | | | |
|---|---|---|---|
| 100.10.01 | Dec. 22, 2010 | Revenue | 100.00 |
| 100.10.01 | Dec. 22, 2010 | Expense | 200.00 |

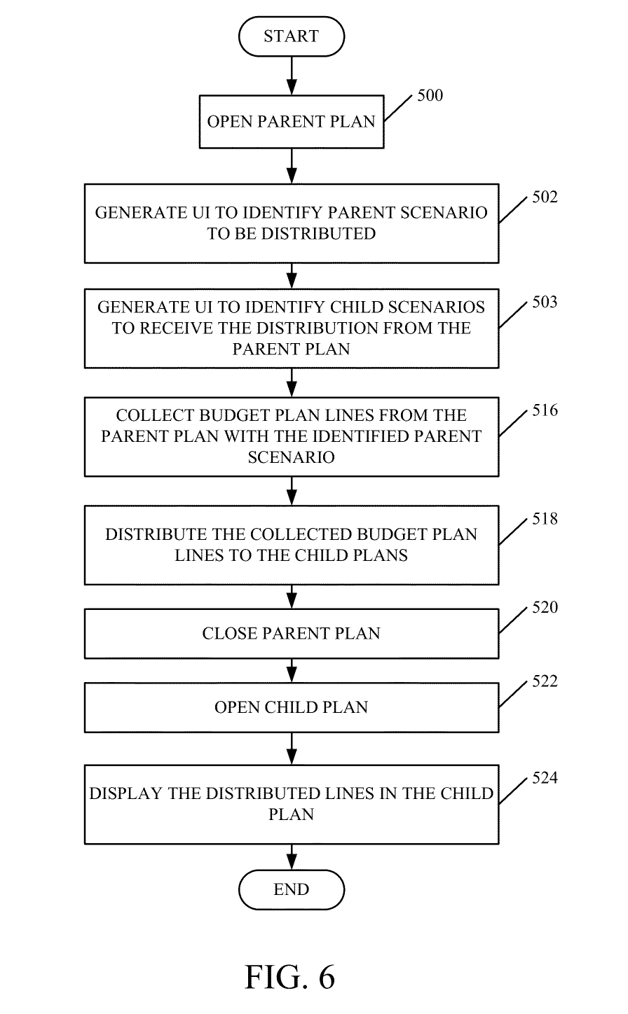

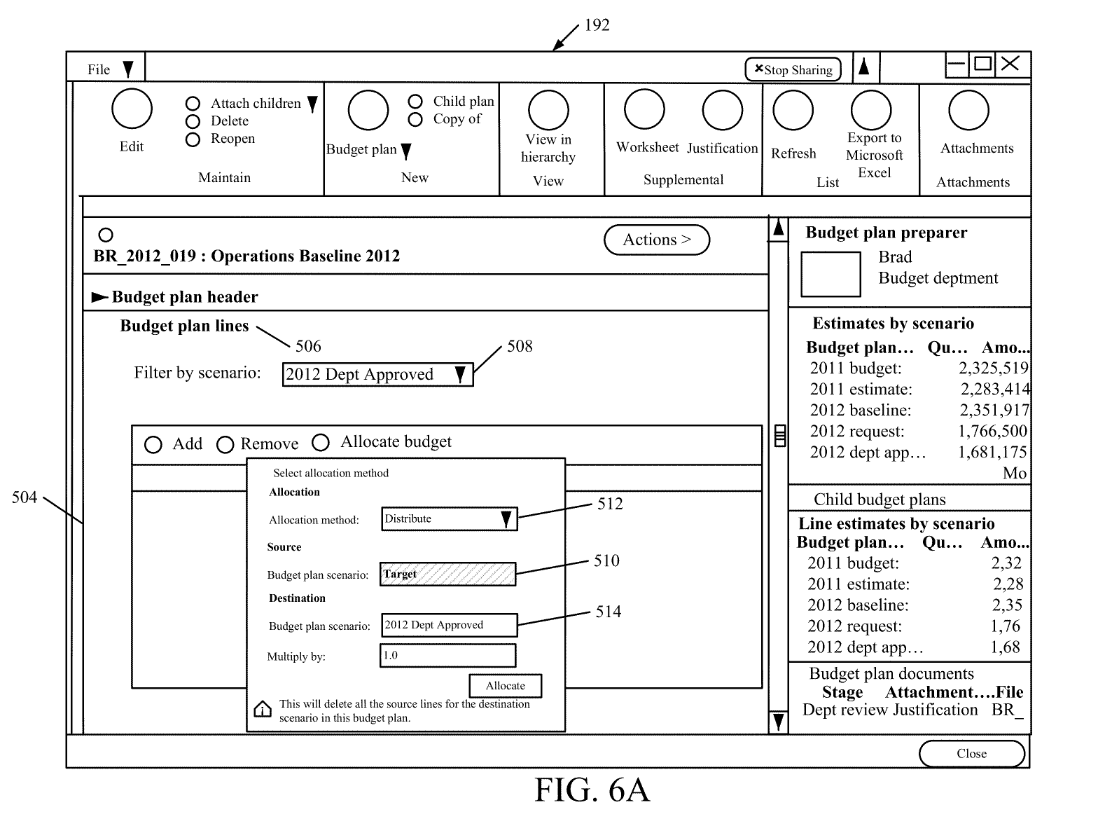

FIG. 6 is a flow diagram illustrating one embodiment of the operation of budget planning system 102 in distributing information from a parent plan down into child plans. This may happen, for instance, when a parent node in the organizational structure wishes to generate a target amount for certain budget items for child nodes in the organizational structure. For instance, an executive node may generate budgetary targets for divisions, each of which have a child plan of the executive plan corresponding to the executive node. In this case, the executives may wish to enter the target amounts in the executive budget plan and have those amounts distributed downward to the various child plans associated with the division budgets. FIG. 6 is a flow diagram illustrating one exemplary way in which this can be done.

A user first illustratively opens a parent plan that has scenarios that are to be distributed down to child plans. This is indicated by block 500 in FIG. 6. Budget planning component 128 then generates a user interface to identify a parent scenario in the parent plan that is to be distributed to the child plans. This is indicated by block 502 in FIG. 6. Budget planning component 128 also generates a user interface display that can be used to identify the child scenarios that are to receive the distribution from the identified parent scenario in the parent plan. This is indicated by block 503 in FIG. 6.

FIG. 6A shows one embodiment of a user interface display 504 that can be generated for this purpose. In user interface 504, the user has selected a parent budget plan (BR_{—}2012_{—}019: operations baseline 2012). The user has then selected the “budget plan lines” button 506 and selected a scenario that is to be allocated (or distributed downward) to child plans in dropdown menu 508. It can be seen that the user has selected the “2012 DEPT approved” scenario. This causes budget planning component 128 to generate user interface box 510 which shows that the “2012 DEPT approved” scenario is the destination in the child plans for the parent plan “target” scenario. The user can choose the particular type of allocation method, in this case, “distribute” using dropdown menu 512. When distribution is properly configured, the user simply actuates the “allocate” button 514 and this causes the “target” budget plan scenario in the parent plan to be distributed downward to the “2012 DEPT approved” budget plan scenario in the associated child plans.

Budget planning component 128 then collects the budget plan lines from the parent plan (in this case the “target” budget plan scenarios) and distributes the collected budget plan lines to the destination scenarios identified in the child plans. This is indicated by blocks 516 and 518 in FIG. 6.

The user can then close the parent plan and open one of the associated child plans. When this is done, the associated child plan is displayed with the distributed lines already populated into the child plan. This is indicated by blocks 520, 522 and 524 in FIG. 6.

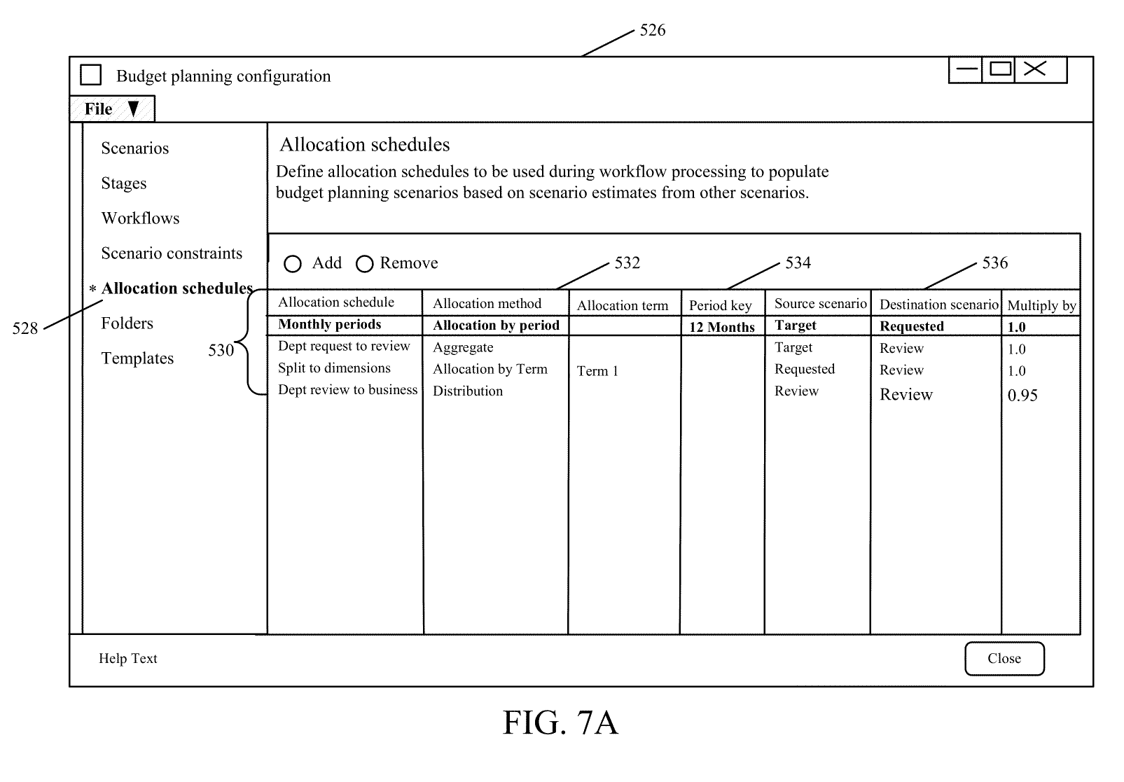

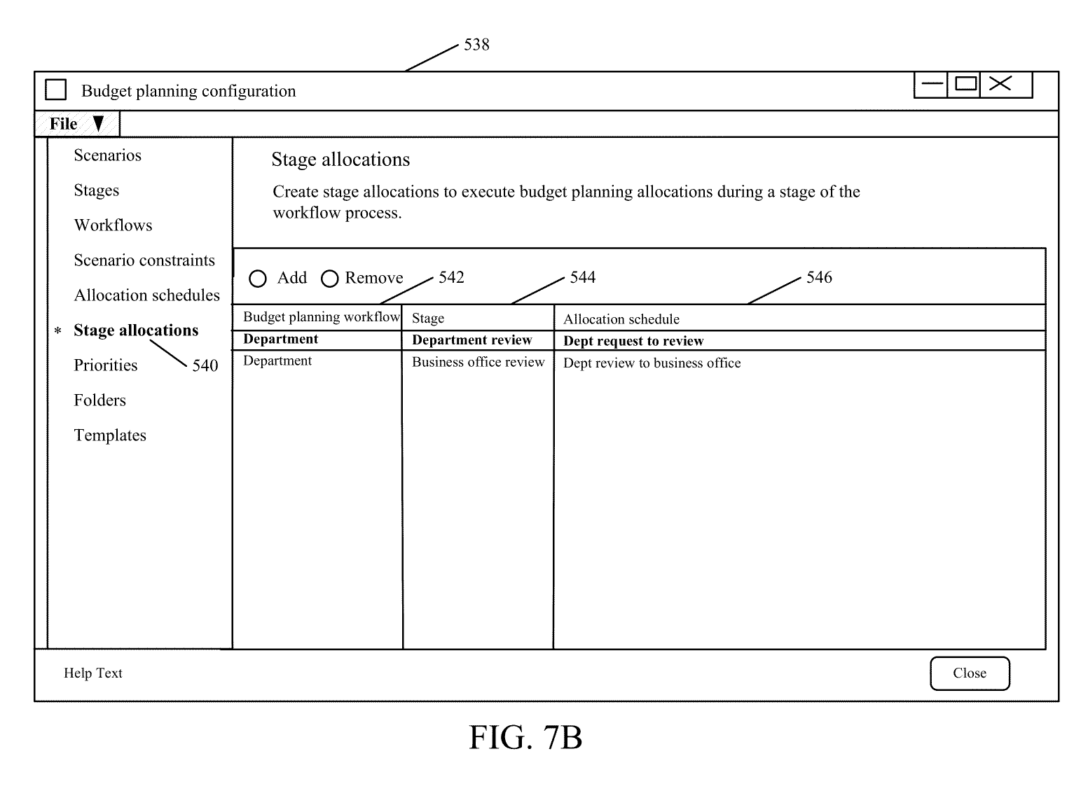

It should be noted that the same sort of process discussed with respect to FIG. 6 can be used to populate one budget plan scenario from one or more other budget plan scenarios through associated plans (not necessarily a parent or child but a sibling) or from within a single plan. In order to do that, budget planning component 128 illustratively generates a suitable user interface display that allows a user to specify not only the source scenario where the information is to be obtained, but the destination scenario, where the information is to be aggregated or distributed. FIG. 7A shows one embodiment of a user interface display 526 that can be used for this purpose.

User interface display 526 shows that the user has selected the allocations schedule button 528. This causes budget planning component 128 to generate a list of allocation schedules 530. The user can define an allocation method at 532 (such as aggregate, distribute, allocate, etc.). Among other things, the user can then define the source scenario 534 which is the source of the allocation and the destination scenario 536 which is the destination of the allocation. In the embodiment shown in FIG. 7A, it can be seen that the user has selected the “monthly periods” allocations schedule and indicated that the allocation method is to be an “allocation by period”. The user has defined the source scenario as the “target” budget plan scenario and the destination scenario as the “requested” budget plan scenario. Therefore, budget planning component 128 will allocate the amounts in the source scenario to the destination scenario during the budget planning process.

The allocation schedule defined in FIG. 7A can be applied in various stages. That is, the user can create stage allocations to execute budget planning allocations during a stage of a given workflow process. FIG. 7B shows a user interface display 538 that can be used for this process. The user has selected the “stage allocations” button 540 which allows the user to identify a budget planning workflow 542 and a specific stage in that workflow 544. The user can then identify an allocation schedule 546 to be executed during that stage of the identified workflow.

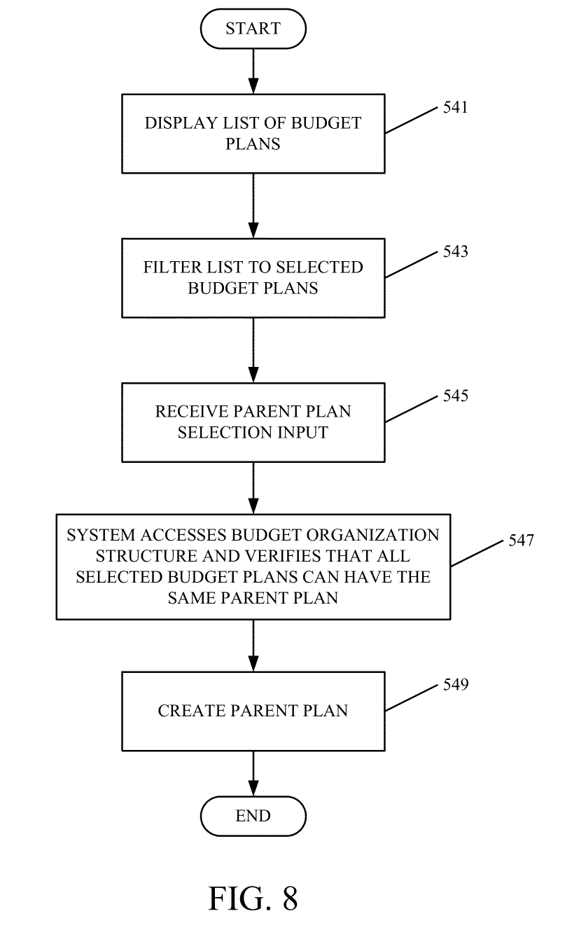

In one embodiment, budget planning component 128 also allows a user to create a parent budget plan for a set of children budget plans. FIG. 8 is a flow diagram showing one illustrative way in which this can be done. First, budget planning component 128 generates a display that lists various budget plans. This is indicated by block 541 in FIG. 8. The user then selects one or more of the plans from the list of budget plans that are displayed. Filtering the list to only selected budget plans is indicated by block 543 in FIG. 8. Budget planning component 128 then receives a parent plan selection input from the user, on the user interface display, that selects a parent plan that is to be assigned as the parent to the selected budget plans. This is indicated by block 545 in FIG. 8. In one embodiment, this can be done where the user is a member of a role that has permission to form this operation. In addition, none of the selected budget plans can have a different parent budget plan already. All of the selected budget plans are illustratively associated with the same budget planning process, and the budget planning process is to have a status of “in process”. If these requirements are met, the user can illustratively select an already existing budget plan as the parent for the selected budget plans, or the user can specify a new budget plan that is to serve as the parent of the selected budget plans. In response, budget planning component 128 illustratively accesses the budget organization structure (or budget hierarchy) in data store 134 to verify that all of the selected budget plans can have the same parent plan. This is indicated by block 547 in FIG. 8. If so, then budget planning component 128 creates the parent plan for the selected plans, or assigns the selected plans to an existing plan, as its children. This is indicated by block 549 in FIG. 8.

FIG. 9 is a flow diagram illustrating one embodiment of the operation of budget planning component 128 in allowing a user to view and navigate various budget plans 140 in data store 134. In one embodiment, budget planning component 128 generates a list view of existing budget plans for the user. This is indicated by block 550 in FIG. 9. The user may then provide a user input requesting a hierarchical view of the listed budget plans. This is indicated by block 552. In response, budget planning component 128 generates a display of the budget organization hierarchy (or budget hierarchy) 138 corresponding to the list of budget plans. This is indicated by block 554 in FIG. 9. FIG. 4B (discussed above) shows one embodiment of a hierarchy. The user then selects a level in the hierarchy, such as by selecting one of the nodes in the hierarchy. This is indicated by block 556 in FIG. 9. In response, budget planning component 128 generates a display showing not only a node corresponding to the selected level in the budget hierarchy, but also showing parent budget plans and child budget plans and the relationships of those plans to the selected node on the selected level of the hierarchy. This is indicated by block 558 in FIG. 9. FIG. 2C (again discussed above) shows one embodiment of such a user interface display.

Component 128 then receives user actuation of a budget plan from the hierarchy shown in FIG. 2C. That is, the user can simply click on one of the nodes in the hierarchy of FIG. 2C, or otherwise select or actuate one of the nodes. This is indicated by block 560 in FIG. 9. In response, component 128 displays the details of the actuated budget plan. This is indicated by block 562 in FIG. 9. In one embodiment, component 128 also applies security so that the user may only be allowed to see sections of the actuated budget plan, or may blocked from viewing the budget plan, entirely.

FIG. 2B shows a display of the various details of the selected budget plan, as indicated by 184 in FIG. 2B. The details include, by way of example only, the status of the individual workflows in the budget plan. FIG. 2B shows that four workflows have not been submitted, five are in review, ten are approved, and none are rejected or canceled. Of course, these are exemplary status indicators only. Details can also include an enumeration of the stages, a summary of the amounts for various scenarios that have an amount value, the summary of units of various scenarios that have a unit value, and a list of various budget plans in the hierarchy being displayed. Of course, these details are exemplary only and different or additional details could be used as well.

It can thus be seen that the system supports aggregation of an organization hierarchy for budgeting into the budgeting process, and also easily supports organizational changes. By simply redefining or modifying the budget hierarchy, the user can accommodate such changes quickly. The system also introduces multiple levels of parallel workflows to orchestrate the budget planning process. Workflow-specific budget planning stage management controls data visibility, security, and presentation. That is, at each stage in a budget plan, the user can set rules that control whether various other users or roles can see certain types of data, and whether they can make any changes to that data in the budget plan. The system can be used to easily manage bottom-up types of budget planning and top-down types of budget planning, or any combination of those, as defined by the process.

At each node in the budget organizational hierarchy a budget planning workflow is used to define the stages of review that an individual budget plan transitions through. Nodes at a specific level in the hierarchy may reuse the same workflow, but have different reviewers and requestors. Workflow providers can be used to automatically enforce that the budget plans are reviewed by the appropriate individuals with responsibility for the organization unit and budget. By tying the budget planning process to the organizational structure, the system provides a tighter level of data control and security. With each stage in the budget planning workflow, there are a set of rules that dictate what can be used to control what values for the budget planning and what areas are visible and able to be modified.

Also, within each level in the hierarchy, it is possible to have multiple budget plans so they can be ranked. The plans can be associated in parent/child relationship or in other desired ways. This allows the budgeting information to be summarized at a higher level for review and adjustment. Within a specific step in the workflow, and based on the budget planning stage, automated tasks can be used to aggregate the data upward or allocate it downward. This automatic transition controls the significant problem with budgeting systems—keeping the data controlled and synchronized at each review level. Rules are defined for how this aggregation is done. Such rules, as described above, can include splitting annual amounts to monthly amounts or creating best-case and worse-case estimates, and this can all be managed through the allocation rules.

In addition, while some specific examples were discussed above, it will be noted that a wide variety of changes can be made, and those changes are contemplated by the present discussion. The budget planning orchestration can automatically be performed by processor 124 or another processor or workflow orchestration engine that has access to the stored budget plans.

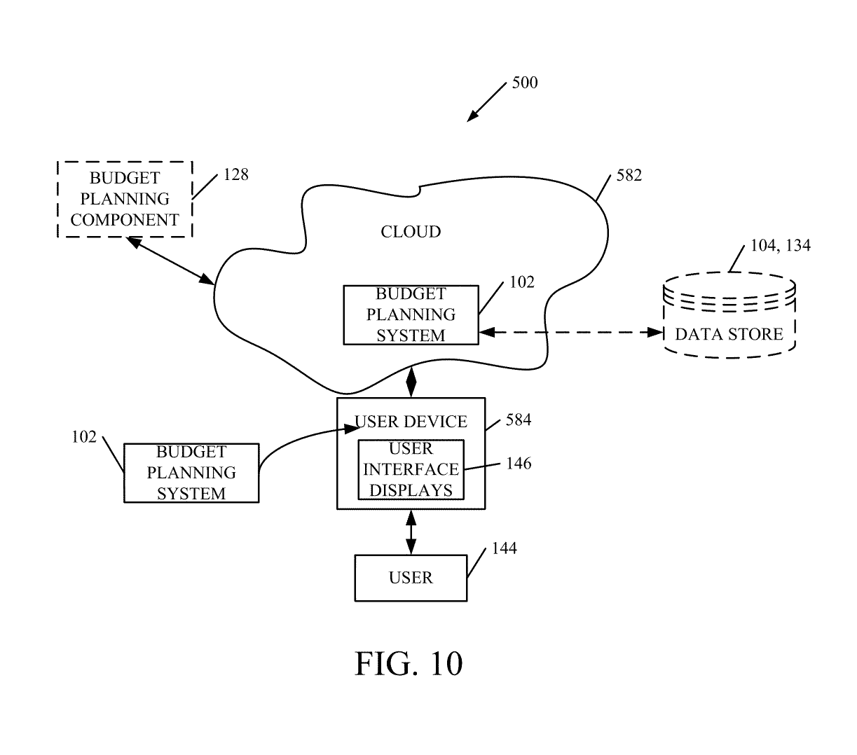

FIG. 10 is a block diagram of system 100, shown in FIG. 1, except that it is disposed in a cloud computing architecture 580. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 10, some items are similar to those shown in FIG. 1 and they are similarly numbered. FIG. 10 specifically shows that business system 100 is located in cloud 582 (which can be public, private, or a combination where portions are public while others are private). Therefore, user 144 uses a user device 584 to access those systems through cloud 582.

FIG. 10 also depicts another embodiment of a cloud architecture. FIG. 10 shows that it is also contemplated that some elements of business system 100 are disposed in cloud 582 while others are not. By way of example, data store 134 can be disposed outside of cloud 582, and accessed through cloud 502. In another embodiment, budget planning component 128 is also outside of cloud 582. Regardless of where they are located, they can be accessed directly by device 584, through a network (either a wide area network or a local area network), they can be hosted at a remote site by a service, or they can be provided as a service through a cloud or accessed by a connection service that resides in the cloud. System 100, or portions of it, can also be disposed on device 584. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

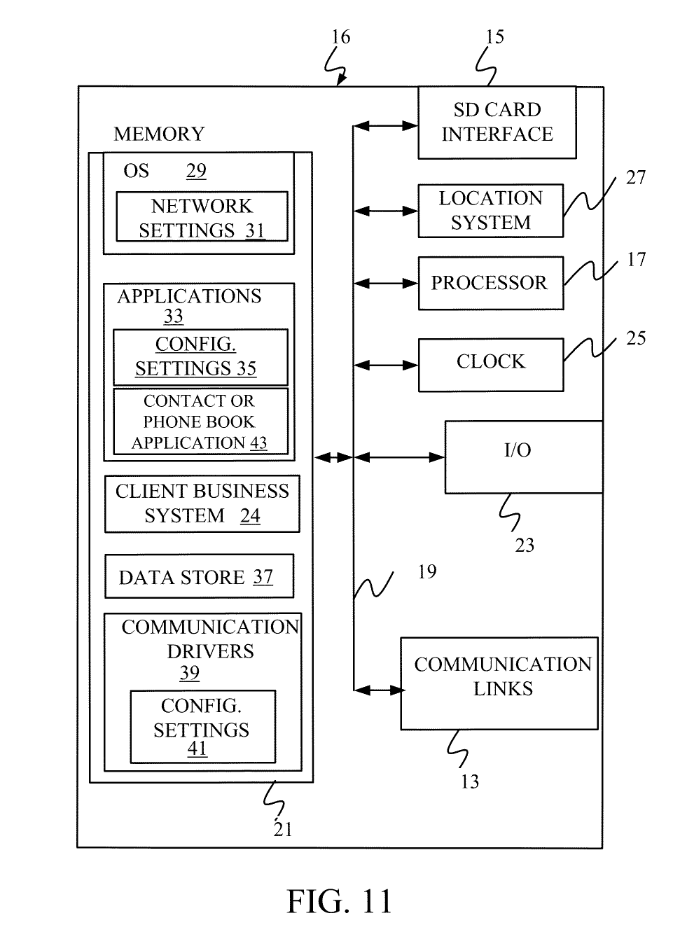

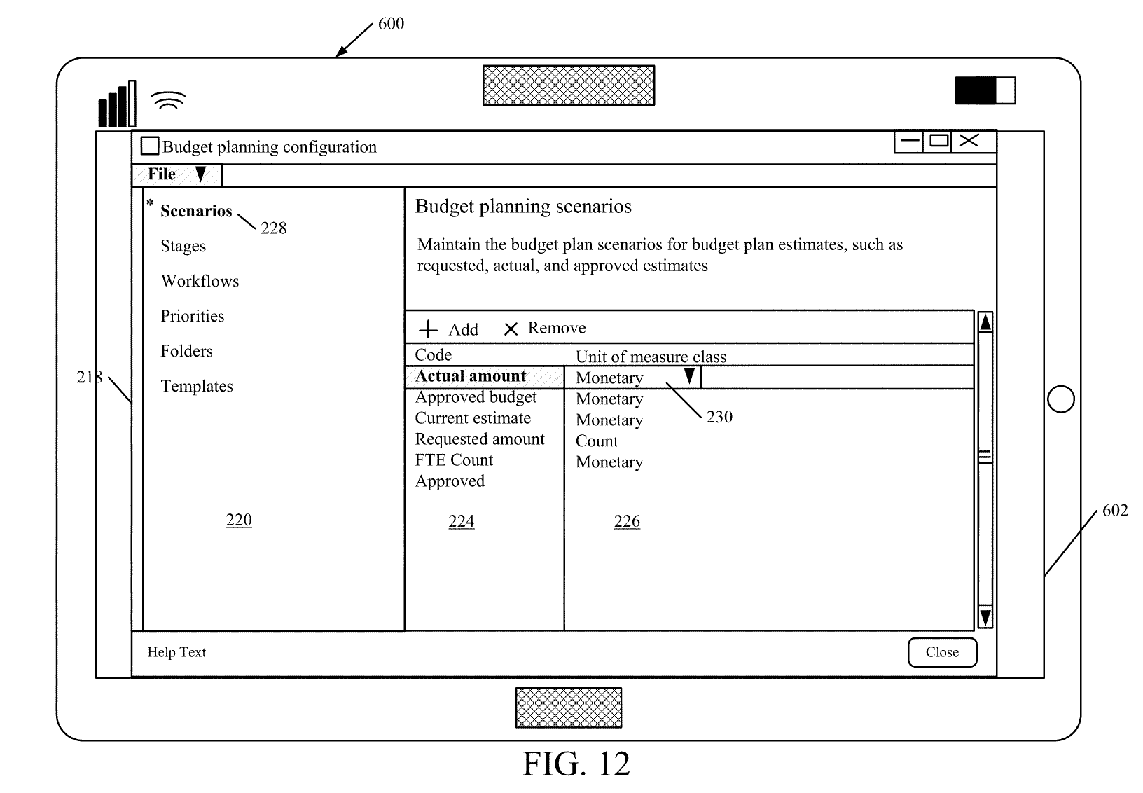

FIG. 11 is a simplified block diagram of one illustrative embodiment of a handheld or mobile computing device that can be used as a user's or client's hand held device 16, in which the present system (or parts of it) can be deployed. FIGS. 12-15 are examples of handheld or mobile devices.

FIG. 11 provides a general block diagram of the components of a client device 16 that can run components of system 100 or that interacts with system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like system 100) are received on a removable Secure Digital (SD) card that is connected to a SD card interface 15. SD card interface 15 and communication links 13 communicate with a processor 17 (which can also embody processors 124 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. System 100 or the items in data store 110, for example, can reside in memory 21. Similarly, device 16 can have a client business system 24 which can run various business applications or embody parts or all of business system 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

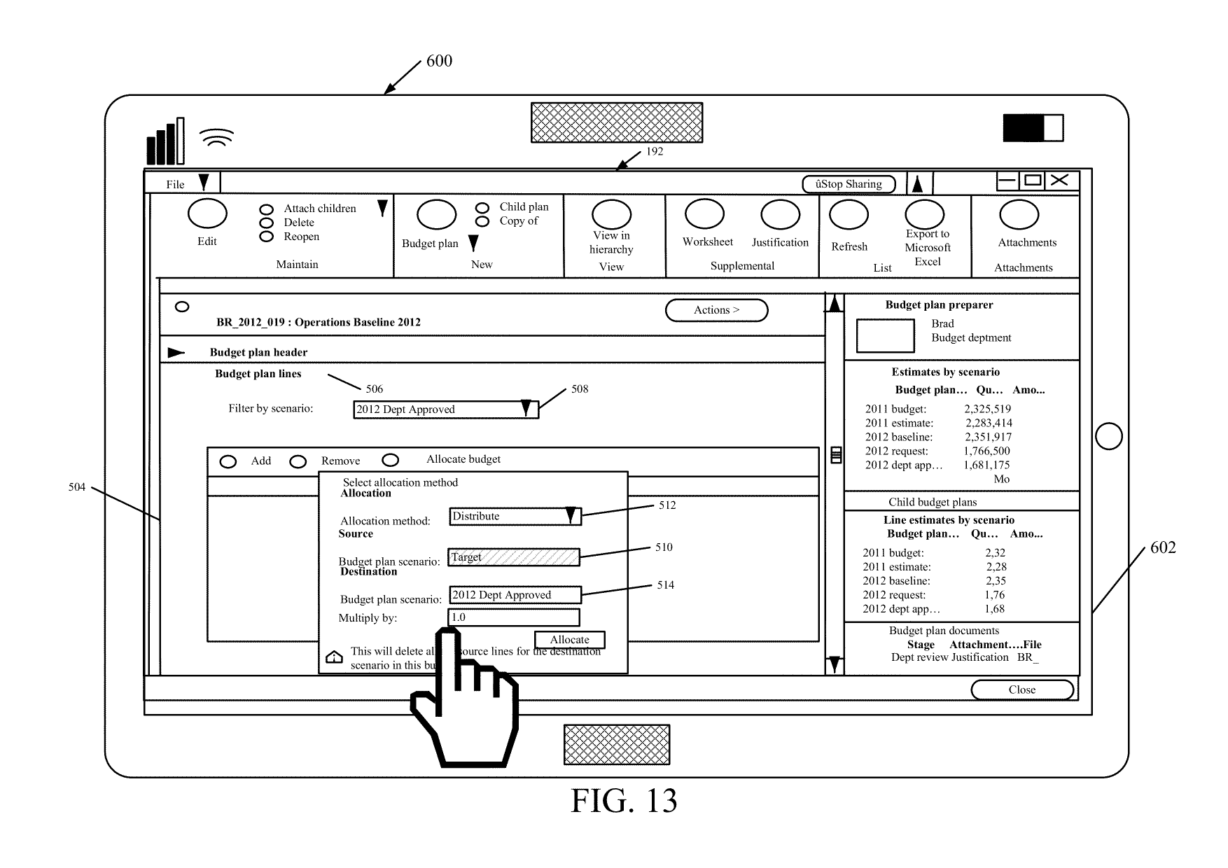

FIGS. 12 and 13 show one embodiment in which device 16 is a table computer 600. In FIG. 12, computer 600 is shown with user interface display 218 from FIG. 3C displayed on the display screen 602. FIG. 13 shows computer 600 with user interface display 504 from FIG. 6A displayed on display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

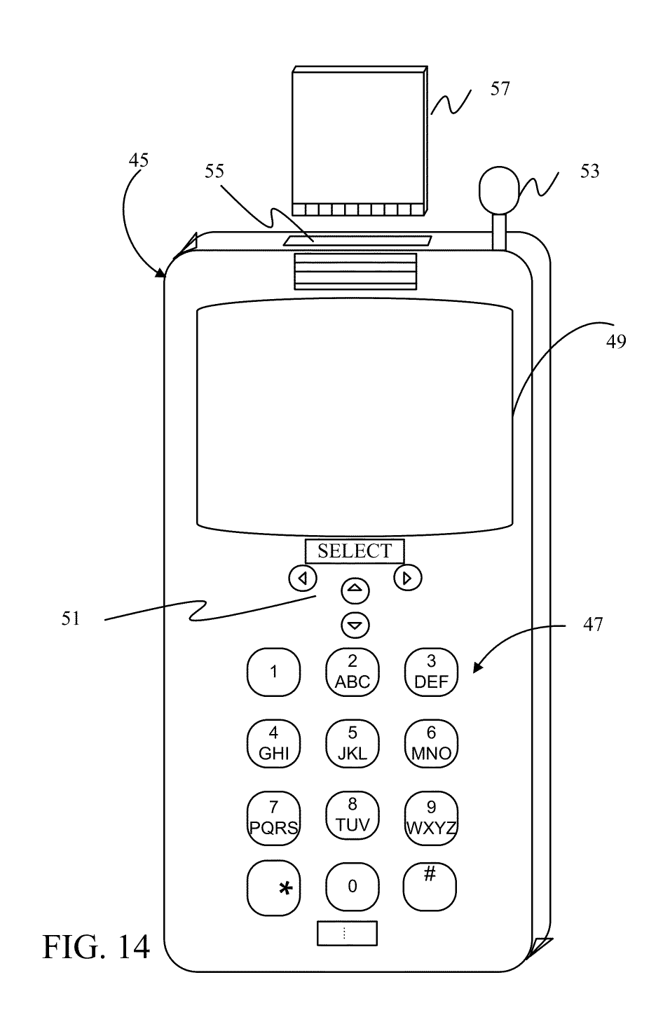

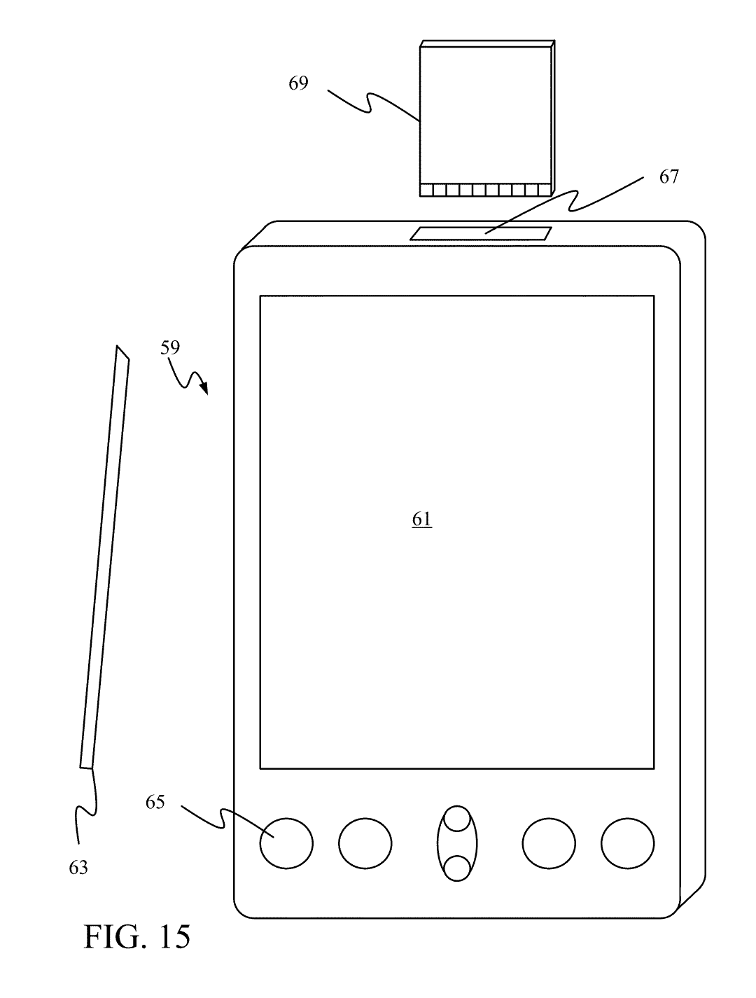

FIGS. 14 and 15 provide additional examples of devices 16 that can be used, although others can be used as well. In FIG. 14, a smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 15 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

Note that other forms of the devices 16 are possible.

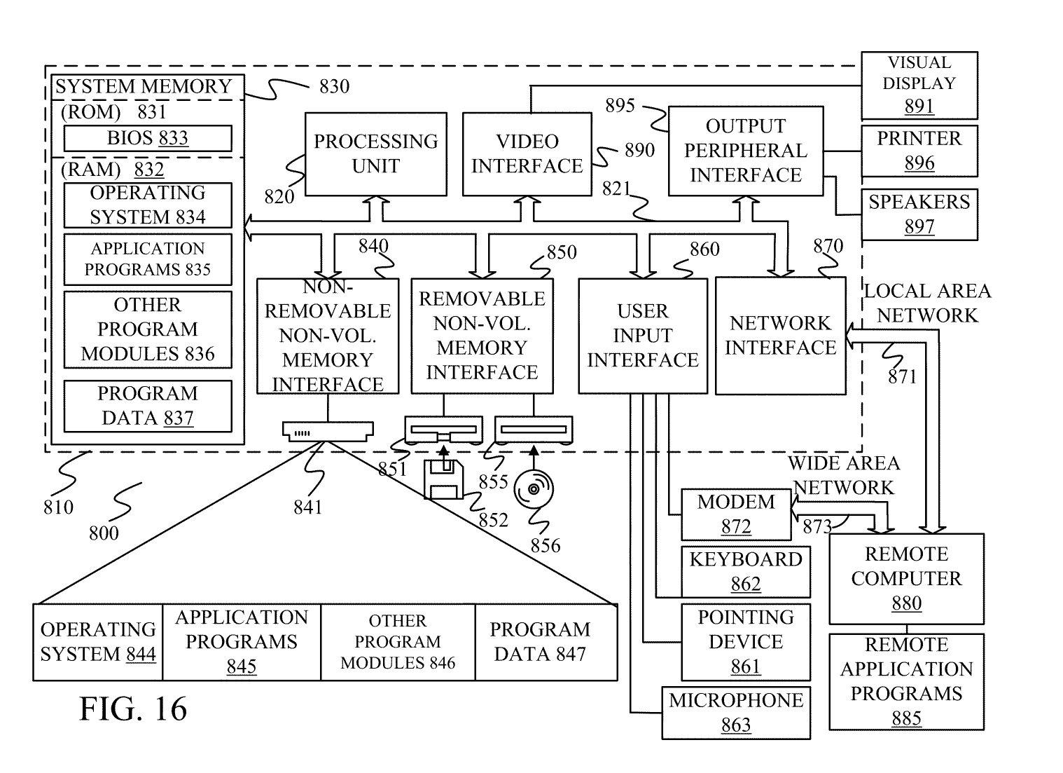

FIG. 16 is one embodiment of a computing environment in which system 100 (for example) can be deployed. With reference to FIG. 16, an exemplary system for implementing some embodiments includes a general-purpose computing device in the form of a computer 810. Components of computer 810 may include, but are not limited to, a processing unit 820 (which can comprise processor 124), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 16.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 16 illustrates operating system 834, application programs 835, other program modules 836, and program data 837.

The computer 810 may also include other removable/non-removable volatile/nonvolatile computer storage media. By way of example only, FIG. 16 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 16, provide storage of computer readable instructions, data structures, program modules and other data for the computer 810. In FIG. 16, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 16 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 16 illustrates remote application programs 885 as residing on remote computer 880. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method of orchestrating a budget plan process, comprising:
displaying, on a display device,a budget organizational hierarchy having hierarchically arranged nodes;
receiving a first selection input selecting a first node in the budget organizational hierarchy;
displaying, on a display device, budget plan generation user interface (UI) displays with user input mechanisms;
receiving first budget plan inputs, through the user input mechanisms on the budget plan generation UI displays, the first budget plan inputs defining a corresponding first budget plan for the first node, the user input mechanisms including stages user input mechanisms to receive user inputs to define stages in the budget plan, and to order the stages according to a workflow; and
automatically executing tasks in the stages, with a computer processor, according to the workflow in the first budget plan to orchestrate the budget plan process.

2. The computer-implemented method of claim 1 and further comprising:
receiving a second selection input selecting a second node in the budget organizational hierarchy;
displaying budget plan generation user interface (UI) displays;
receiving second budget plan inputs, through the budget plan generation UI displays, defining a corresponding second budget plan for the second node, the second budget plan inputs further defining stages ordered according to a second workflow; and
receiving a user input establishing a dependency relationship between the first and second budget plans.

3. The computer-implemented method of claim 2 wherein receiving the first and second budget plan inputs comprises:
receiving configuration inputs configuring items in the corresponding budget plan; and
receiving process inputs defining the process for the corresponding budget plan.

4. The computer-implemented method of claim 3 wherein receiving configuration inputs comprises:
displaying a review workflow UI display with a user input mechanism; and
receiving review workflow user inputs through the user input mechanism on the review workflow UI display to define a review workflow for the corresponding budget plan.

5. The computer-implemented method of claim 4 wherein receiving configuring inputs comprises:
displaying an information type UI display with a user input mechanism; and
receiving information type user inputs through the user input mechanism on the information type UI display to define types of information used in the corresponding budget plan.

6. (canceled)

7. The computer-implemented method of claim 5 wherein receiving configuration inputs comprises:
displaying a workflow UI display with a user input mechanism; and
receiving workflow user inputs through the user input mechanism on the workflow UI display to define the workflows used in the corresponding budget plan.

8. The computer-implemented method of claim 7 wherein receiving configuration inputs comprises:
displaying a priorities UI display with a user input mechanism; and
receiving priority user inputs through the user input mechanism on the priorities UI display to define priorities that can be assigned to the corresponding budget plan.

9. The computer-implemented method of claim 8 wherein receiving process inputs comprises:
displaying a new process UI display with a user input mechanism; and
receiving new process user inputs through the user input mechanism on the new process UI display to create a new budget planning process for the corresponding budget plan.

10. The computer-implemented method of claim 9 wherein receiving process inputs comprises:
displaying a workflow assignment UI display with a user input mechanism; and
receiving workflow assignment user inputs through the user input mechanism on the workflow assignment UI display to define responsibility centers used in the corresponding budget plan and assign a workflow to each responsibility center.

11. The computer-implemented method of claim 10 wherein receiving process inputs comprises:
displaying a stage rules UI display with a user input mechanism; and
receiving stage rules user inputs through the user input mechanism on the stage rules UI display to define rules that apply at each stage in each workflow in the corresponding budget plan.

12. The computer-implemented method of claim 11 wherein the rules define what operations can be performed by a user at each stage and include security rules for limiting access to information at each stage.

13. The computer-implemented method of claim 11 wherein receiving process inputs comprises:
displaying an aggregation UI display with a user input mechanism; and
receiving aggregation user inputs through the user input mechanism on the aggregation UI display to define a destination scenario in the corresponding budget plan and source scenarios from descendent budget plans, the destination scenario receiving aggregation of information from the source scenarios.

14. The computer-implemented method of claim 11 wherein receiving process inputs comprises:
displaying a distribution UI display with a user input mechanism; and
receiving distribution user inputs through the user input mechanism on the distribution UI display to define a source scenario in the corresponding budget plan and destination scenarios in descendent budget plans, the destination scenarios receiving distribution of information from the source scenarios.

15. The computer-implemented method of claim 11 wherein receiving process inputs comprises:
displaying an allocation UI display with a user input mechanism; and
receiving allocation user inputs through the user input mechanism on the allocation UI display to define a destination scenario in the corresponding budget plan and source scenarios from another budget plan, the destination scenario receiving allocation of information from the source scenarios.

16. The computer-implemented method of claim 11 wherein receiving process inputs comprises:
displaying template UI display with a user input mechanism; and
receiving template user inputs through the user input mechanism on the template UI display to define templates and template storage locations for collecting information at each stage in the corresponding budget plan.

17. The computer-implemented method of claim 11 wherein receiving process inputs comprises:
displaying a priority assignment UI display with a user input mechanism; and
receiving priority assignment user inputs through the user input mechanism on the priority assignment UI display to assign a priority to the corresponding budget plan.

18. A budget planning system, comprising:
a hierarchy generation component for displaying hierarchy generation user interface (UI) displays with user input mechanisms that receive hierarchy touch gesture user inputs to generate a budget hierarchy having hierarchically arranged nodes;
a budget planning component for displaying budget plan generation UI displays with budget plan user input mechanisms that receive budget plan touch gesture user inputs to generate a budget plan for each node in the budget hierarchy; and
a computer processor, being a functional part of the system and activated by the hierarchy generation component and the budget planning component generate the budget hierarchy and the budget plan for each node and automatically orchestrating the budget plan for each node.

19. The budget planning system of claim 18 wherein the computer processor automatically transitions each budget plan through stages in each of a plurality of different workflows defined in each corresponding budget plan.

20. A computer readable storage medium storing computer readable instructions which, when executed by a computer, cause the computer to perform a method comprising:
displaying a budget organizational hierarchy display having hierarchically arranged nodes;
receiving a first selection input, through the budget organizational hierarchy display, selecting a first node in the budget organizational hierarchy;
displaying budget plan generation user interface (UI) displays with first user input mechanisms;
receiving first budget plan touch gesture inputs, through the first user input mechanisms on the budget plan generation UI displays, the first budget plan touch gesture inputs defining a corresponding first budget plan for the first node, with stages ordered according to a workflow;
receiving a second selection input through the budget organizational hierarchy display, selecting a second node in the budget organizational hierarchy;
displaying budget plan generation user interface (UI) displays with second user input mechanisms;
receiving second budget plan touch gesture inputs, through the second user input mechanisms on the budget plan generation UI displays, the second budget plan touch gesture inputs defining a corresponding second budget plan for the second node, with stages ordered according to a second workflow;
displaying a dependency display to receive a user input establishing a dependency relationship between the first and second budget plans; and
automatically executing tasks in the stages according to the workflows in the first and second budget plans, based on the dependency, to orchestrate the budget plan process.
